(19) United States
(12) Patent Application Publication
(10) Pub. No.: US 2002/0154243 A1
(43) Pub. Date: Oct. 24, 2002

(54) Compact digital camera system

(76) Inventors: Keith Glen Fife, Cambridge, MA (US); Lane Gearle Brooks, Somerville, MA (US); Hae-Seung Lee, Bedford, MA (US)

Correspondence Address: TESTA, HURWITZ & THIBEAULT, LLP, HIGH STREET TOWER, 125 HIGH STREET, BOSTON, MA, 02110, US

(21) Appl. No.: 10/024,913

(22) Filed: Dec. 19, 2001

Related U.S. Application Data
(60) Provisional application No. 60/256,782, filed on Dec. 19, 2000.
(60) Provisional application No. 60/261,023, filed on Jan. 11, 2001.
(60) Provisional application No. 60/329,962, filed on Oct. 17, 2001.

(51) Int. Cl. H04N 5/225

(52) U.S. Cl. 348/372

(57) ABSTRACT

A compact digital camera including a control subsystem, which itself includes a microprocessor, and an imaging subsystem and a power management subsystem, each in communication with the control subsystem. The imaging subsystem includes a retractable and extendable lens holder including a lens mount adapted to hold a lens assembly, a camera body surface and a biasing component positioned between the lens mount and the camera body surface. The biasing component is configured to move the lens assembly from a stored position to an operating position. The power management subsystem includes power selection-isolation circuitry, battery charging circuitry in communication with the power selection-isolation circuitry and power arbitration circuitry.

### CROSS-REFERENCE TO RELATED APPLICATIONS

This application claims priority to U.S. provisional application Ser. No. 60/256,782 which was filed on Dec. 19, 2000, the entirety of which is hereby incorporated by reference, U.S. provisional application Ser. No. 60/261,023 which was filed Jan. 11, 2001, the entirety of which is hereby incorporated by reference, and U.S. provisional application Ser. No. 60/329,962 which was filed Oct. 17, 2001, the entirety of which is hereby incorporated by reference.

### FIELD OF THE INVENTION

The present invention relates generally to photography and, more specifically, to a compact digital camera system.

### BACKGROUND OF THE INVENTION

The use of digital cameras has increased greatly over recent years. Advances in imaging technology, coupled with the continuing advancements in low-cost processing and high-density memory storage have allowed digital cameras to become successful in the commercial marketplace. Users may preview pictures instantly to confirm the desired photograph thereby avoiding development costs associated with unwanted photographs. Digital cameras also offer users flexibility in publishing and distributing images either electronically or physically on personal computer and printer.

Despite the convenience of the digital camera, it has remained a camera devoted to special occasions. People rarely carry a camera with them at all times. Two limiting factors are the size and power requirements. Conventional cameras are too bulky to carry and require frequent battery replacement or recharging.

Conventional digital cameras can be manufactured without many mechanical components. Digital cameras use considerable power, thus they require large batteries which limit miniaturization. Digital cameras also rely on conventional optics for image acquisition and viewfinder functions which further limit miniaturization.

The optical viewfinder generally presents a limitation in the minimization of camera thickness by requiring that a minimum distance be provided between the viewfinder objective lens and the viewfinder eyepiece. As the electronics become increasingly smaller in size, digital cameras can be made smaller and thinner except for this minimum distance requirement.

The taking lens of the camera similarly presents a thickness limitation. In order to provide a reasonable low-light sensitivity and depth of focus for a typical low-cost imager, the taking lens in a digital camera generally includes multiple lens elements. The thickness of the multi-element taking lens can also present a limit to miniaturization.

Users of conventional digital cameras are required to frequently charge or replace camera batteries. If the user does not know that the charge on the camera batteries is low, the use of the camera disabled during a picture taking session. Consequently, the user is burdened by the need to purchase new batteries and/or frequently monitor the battery status.

### SUMMARY OF THE INVENTION

In general, the invention relates to a small, and particularly thin camera having a front-to-back dimension that is less than the focal length of a view finder objective lens. An operator using a view finder eyepiece in cooperation with the view finder objective lens observes the image seen by a camera taking lens. The present invention also controls electrical power, minimizing consumption at all times, enabling the use of a long-life, self-contained, rechargeable power source.

Accordingly, in a first aspect, the invention relates to a digital camera including a control subsystem, which itself includes a microprocessor, and an imaging subsystem and a power management subsystem, each in communication with the control subsystem. The power management subsystem includes power selection-isolation circuitry, battery charging circuitry in communication with the power selection-isolation circuitry and power arbitration circuitry. The power arbitration circuitry is in communication with the power selection-isolation circuitry and the battery charging circuitry.

In one embodiment, the digital camera also includes a user interface subsystem for taking a picture. In another embodiment, the power arbitration circuitry includes a camera wakeup generation module in communication with the user interface subsystem and a failsafe reset module in communication with the wakeup generation module and the microprocessor. In another embodiment, the user interface subsystem includes a user accessible actuator for initiating the acquisition of an image, an inverter having an input in communication with the user accessible actuator and an output in communication with the wakeup generation module, an active pull-up latch in communication with the inverter input and the inverter output, a first active pull-up in communication with the inverter input adapted to receive a first control signal and a second active pull-up in communication with the inverter input adapted to receive a second control signal. In yet another embodiment, the battery charging circuitry includes a first transistor having a first active area a second transistor having a second active area, the second transistor connected to the first transistor in a differential configuration and at least one supplemental transistor having a supplemental active area, the supplemental transistor connected in series with a supplemental switch, the supplemental transistor and supplemental switch further connected in parallel with the second transistor.

In another aspect, the invention relates to a camera body having a tongue and groove configuration. The camera body includes a front cover having a first front edge and a second front edge, each of the first and second front edges having a lip. The camera body also includes a rear cover having a first rear edge and a second rear edge, each of the first and second rear edges having a lip. The camera body also includes a first rail having a groove adapted to receive the lip of the first front edge and the lip of the first rear edge and a second rail also having a groove adapted to receive the lip of the second front edge and the lip of the second rear edge. The front cover and the rear cover are held in substantially parallel alignment when the front edge lip and the rear edge lip are received in the groove of the first rail and the second rail, respectively.

In another aspect, the invention relates to a rechargeable camera power source including a printed circuit board having a first side, a second side and a pair of conductive pads positioned on the second side. The printed circuit board defines a pair of apertures, each of the apertures being configured to provide a passage between the first side and the second side. The rechargeable camera power source also includes a rechargeable battery. The rechargeable battery includes a planar battery body positioned substantially parallel and adjacent to the first side of the printed circuit board and a pair of conformable battery terminals, each of the terminals passing through a respective board aperture and bonded to a respective one of the conductive pads.

In another aspect, the invention relates to a retractable and extendable lens holder including a lens mount adapted to hold a lens assembly, a camera body surface and a biasing component positioned between the lens mount and the camera body surface. The biasing component is configured to move the lens assembly from a stored position to an operating position.

In another aspect, the invention relates to a retractable and extendable lens holder including a lens mount adapted to hold a lens assembly, a camera body surface and a pivoting linkage coupled to the camera body surface and the lens mount. The pivoting linkage is adapted to move the lens mount between a first position adjacent to an imager chip and a second position in front of the imager chip, wherein an axis of the lens assembly is substantially normal to and centered on an imaging surface of the imager chip when the lens mount is in the second position.

In another aspect, the invention relates to a retractable and extendable lens holder including a lens holder, a camera body surface, a ramp arm having a pivot axis parallel to the camera body surface, a retraction device coupled to the ramp arm and an angular bias component. The angular bias component has a first bias arm, a second bias arm and a bias axis, the bias axis being parallel to pivot axis. The retraction device moves the ramp arm to a first position when in an operating position and the retraction device moves the ramp arm to a second position when in a stored position.

### BRIEF DESCRIPTION OF FIGURES

The invention is pointed out with particularity in the appended claims. The advantages of the invention may be better understood by referring to the following description taken in conjunction with the accompanying drawings in which:

FIG. 1 is a block diagram depicting one embodiment of the invention;

FIG. 2A is an image depicting a front view of one embodiment of the invention;

FIG. 2B is an image depicting a rear view of one embodiment of the invention;

FIG. 3A is a schematic diagram depicting the front cover of the embodiment of the invention shown in FIG. 2A;

FIG. 3B is a schematic diagram depicting the end view of the front cover of the embodiment of the invention shown in FIG. 2A;

FIG. 4A is a schematic diagram depicting the back cover of the embodiment of the invention shown in FIG. 2B;

FIG. 4B is a schematic diagram depicting the end view of the back cover of the embodiment of the invention shown in FIG. 2B;

FIG. 5A is a mechanical drawing depicting a top rail of the invention shown in FIGS. 2A and 2B;

FIG. 5B is a mechanical drawing depicting a bottom rail of the invention shown in FIGS. 2A and 2B;

FIG. 6 depicts a left end cap of the invention shown in FIGS. 2A and 2B;

FIG. 7 is a right end cap of the invention shown in FIGS. 2A and 2B;

FIG. 8A is an isometric drawing depicting a front view of an alternative embodiment of the invention;

FIG. 8B is an isometric drawing depicting a rear view of the alternative embodiment shown in FIG. 8A;

FIG. 9 is a more detailed schematic drawing depicting the taking lens and imager chip of the embodiment of the invention shown in FIGS. 2A and 2B;

FIG. 10 is an image illustrating an embodiment of a lens holder spring-loading mechanism according to one embodiment of the invention;

FIG. 11 depicts a top view of an embodiment of a lens holder according to one embodiment of the invention;

FIG. 12 depicts a bottom view of an embodiment of a lens holder according to one embodiment of the invention;

FIG. 13 is an illustration of an embodiment of a lens holder in a retracted state;

FIG. 14 is an illustration of an embodiment of a camera according to the invention showing a lens holder in a extended state;

FIG. 15 is a schematic drawing of a light shield around an imager chip of the invention shown in FIGS. 2A and 2B;

FIG. 16A is a schematic drawing of an embodiment of an extended lens holder according to the invention;

FIG. 16B is a schematic drawing of the lens holder of FIG. 16A shown in a retracted state;

FIG. 17A is a schematic drawing of another embodiment of a lens holder of the invention shown in an extended state;

FIG. 17B is a schematic drawing of the lens holder of FIG. 17A shown in a retracted state;

FIG. 18A is a schematic drawing of another embodiment of a lens holder of the invention shown in a retracted state;

FIG. 18B is a schematic drawing of the lens holder of FIG. 18A shown in an extended state;

FIG. 19 is a schematic drawing of an embodiment of a power source according to the invention;

FIGS. 20 and 21 are schematic drawings illustrating the location of a power source on a printed circuit board according to one embodiment of the invention;

FIG. 22 is an electrical schematic diagram of an embodiment of selection and isolation circuitry according to the invention;

FIG. 23 is an electrical schematic diagram of an embodiment of a battery charging circuitry according to the invention;

FIG. 24 is an electrical schematic diagram of an embodiment of wake-up circuitry according to the invention;

FIG. 25 is an electrical schematic diagram of an embodiment of an actuating portion of user-interface circuitry according to the invention; and

FIG. 26 is a flowchart of one embodiment of a method for updating the firmware of a digital camera according to the invention.

### DETAILED DESCRIPTION

A compact digital camera system according to the invention is small and easy to use. An end user does not have to spend extensive time learning how to use the device, but can begin enjoying its benefits almost immediately. Furthermore, its small size and light weight do not burden the end user with carrying a bulky or unwieldy device. A permanent battery is charged while images are transferred to a host computer, eliminating the need for the end user to replace batteries or provide additional charging time. The ease of use and small size attributes combine to make the camera system a popular accessory.

An embodiment of the compact digital camera system may be described as including five, broadly-defined interconnected functional subsystems:

Control subsystem 120

Imaging subsystem 104

User interface subsystem 108

Storage subsystem 112

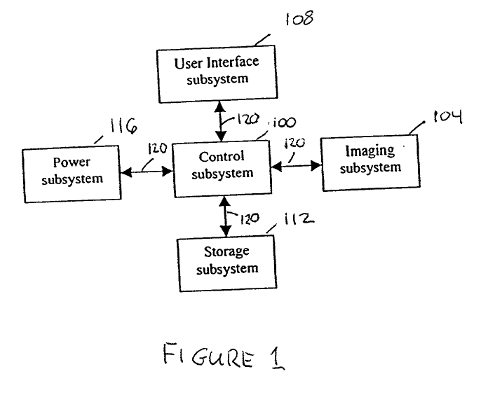

Power subsystem 116 Graphically, these systems interact as shown in FIG. 1, wherein the subsystems are interconnected via a bus 120.

The control subsystem 100 includes hardware logic that may be provided as custom hardware, such as a custom Application Specific Integrated Circuit (hereinafter, “ASIC”), that further includes a microprocessor, memory, and control logic.

In an illustrative embodiment, the hardware control system, for example an ASIC, interfaces with, and directs the operation of, the user interface subsystem 108, the imaging subsystem 104, the power subsystem 116, and the storage subsystem 112. The ASIC also includes a universal serial bus (USB) transceiver that handles the communication between the camera and a “host” PC. During communication, image files are transferred from the camera to the PC. The transfer can be in an industry standard format (examples include JPG, TIFF, GIF, and BMP). Alternatively, the transfer can be accomplished using a proprietary format. Additionally, one or more of data, commands, and software may be transferred to the camera. This facilitates, for example, updates to the camera software or firmware, or both, thereby providing, for example, new or additional functionality. These updates are available to end users through, for example, portable media or the Internet. Test programs to diagnose camera “health” can similarly be provided. These options can substantially reduce the need for end users to return the camera to the manufacturer or service personnel for updates and repairs.

The ASIC also includes the software (e.g., firmware) that controls the camera system. This software is typically stored in nonvolatile memory and is transferred to faster memory when the camera is powered-up (i.e., “booted”). The process of “taking a picture” typically includes acquiring an image, digitizing it, processing it, storing it, and transferring it. Software in the ASIC controls each of these operations.

The imaging subsystem 104 includes a sensor fabricated as an integrated circuit and a lens assembly. The sensor, preferably a CMOS imaging device, can be provided as being capable of a selected resolution, for example, VGA (i.e., 640×480) resolution, in color or black-and-white. A scene in the field of the lens is focused on the sensor. The image is captured when the end user selects an actuator, for example by pressing a shutter button. The sensor converts the optical image to digital data for further processing as well as storage. Image data acquired by the sensor are transmitted across the bus 120 for processing by the ASIC under control of the microprocessor.

The user interface subsystem 108 includes a liquid crystal display that provides status and setting information, typically using a variety of icons. The display is intuitive and is therefore easy to understand. The user interface subsystem also includes several actuators (e.g., buttons) to control the camera, as well as a sounding device that emits tones to, for example, confirm actions or convey status information.

The storage subsystem 112 includes embedded flash memory and (optional) removable memory, such as SD (Secure Digital) and MMC (Multimedia Card) media. More memory means more images (or images with higher resolution) can be stored. The ASIC recognizes the presence of removable media, indicates such on the liquid crystal display, and stores images on the media. With each image, ancillary data can be stored that provide information on the ambient conditions and camera settings present just prior to image acquisition. Ancillary data can include image capture parameters (e.g., exposure time, pixel capture function and gain), camera mode settings, electrical power settings or levels and various image statistics derived from the scene. Example ancillary data includes the image intensity average, offset data for one or more dark columns, a fixed pattern noise row, data indicating the intensity compression implemented for the image, the actual gain setting for the image, and the number of saturated pixels in the image. Such information can be used to model the environment of the camera at the time of image acquisition. The statistical data can be used to modify or image processing algorithms or development of future algorithms. Data associated with the camera settings are typically used by software running on the PC to reconstruct the image after the image is transferred to the PC.

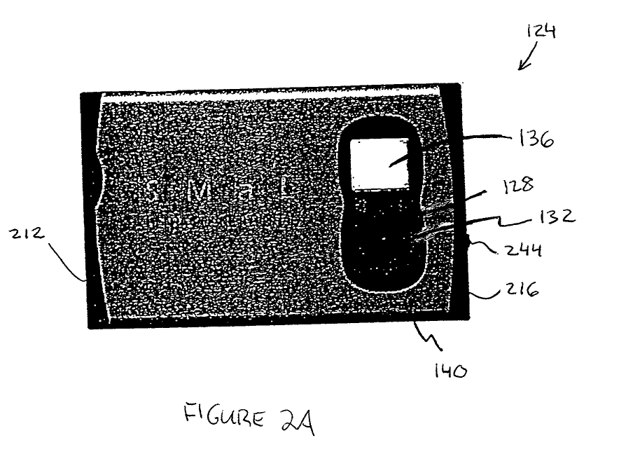

In brief overview and referring to FIGS. 2A and 2B, a camera constructed in accordance with the invention includes a camera body 124; a retractable and extendable lens assembly holder 128; lens assemblies 132 and 136; an interface connector; and an electronics module that implements control of the various subsystems. The electronics module in turn typically includes multiple subsystems, for example, the power source; the power management subsystem; the imaging subsystem and the control subsystem. In the illustrated embodiment the camera has the general shape and size of a conventional credit card. As described in particular detail below, the camera is substantially thinner than the working distance between the viewfinder objective lens 136 and the viewfinder eyepiece 138. The camera body 124 includes a front cover 140 and a back cover 144 that define the general shape of the camera body 124.

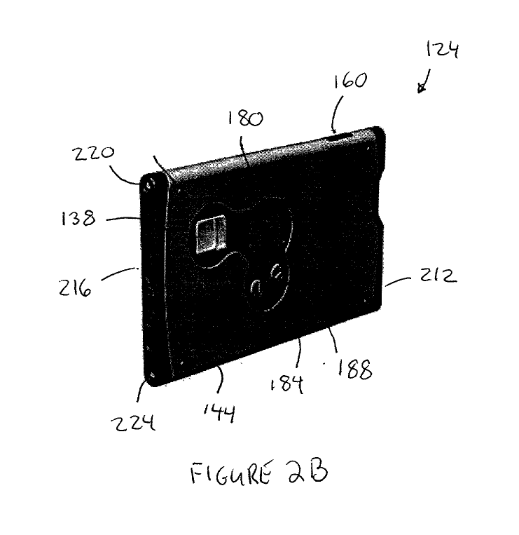

In one embodiment of a mechanical configuration, referring to FIGS. 3A and 3B, the front cover 140 has a substantially rectangular shape and includes an edge 148 defining an opening that permits the lens holder 128 to extend from or retract into the camera body 124. The front cover 140 can include an edge 152 defining an opening that allows the user to easily insert or remove an exchangeable component such as portable storage media (e.g., a flash memory device). Edge 156 is provided to accommodate a shutter button 160 that protrudes from the top of the camera body 124. The front cover 140 is generally planar, but includes a rounded region 164 and lip 168 along the shorter rectangular edge of the cover 140 as shown in an end view in FIG. 3B.

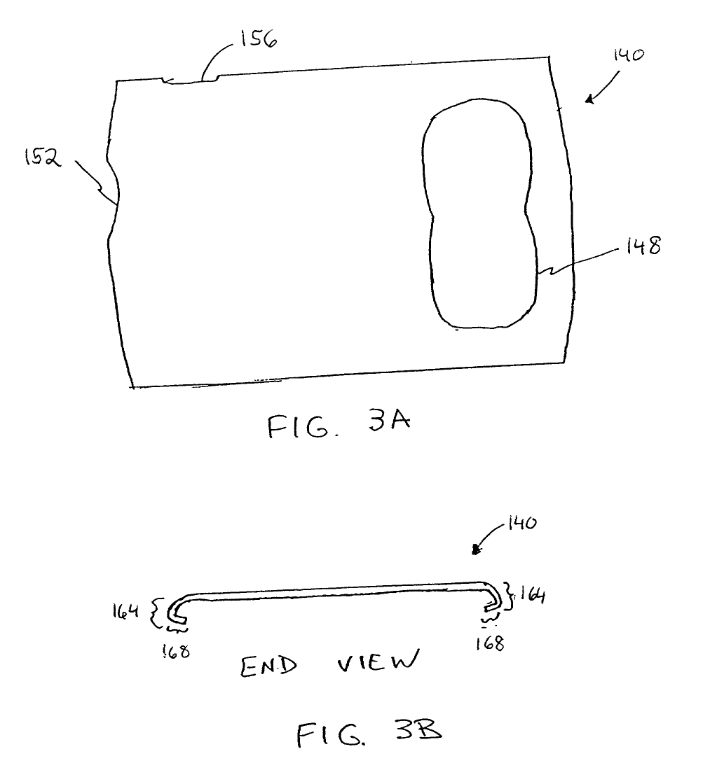

FIGS. 4A and 4B depict the back cover 144 of the camera 124. The back cover 124 has a substantially rectangular shape and includes an edge 176 defining an opening that permits the user access to the viewfinder eyepiece 138, a LCD status display 180 and actuators, such as switches or buttons to control camera functions (e.g., mute button 184 and picture size button 188).

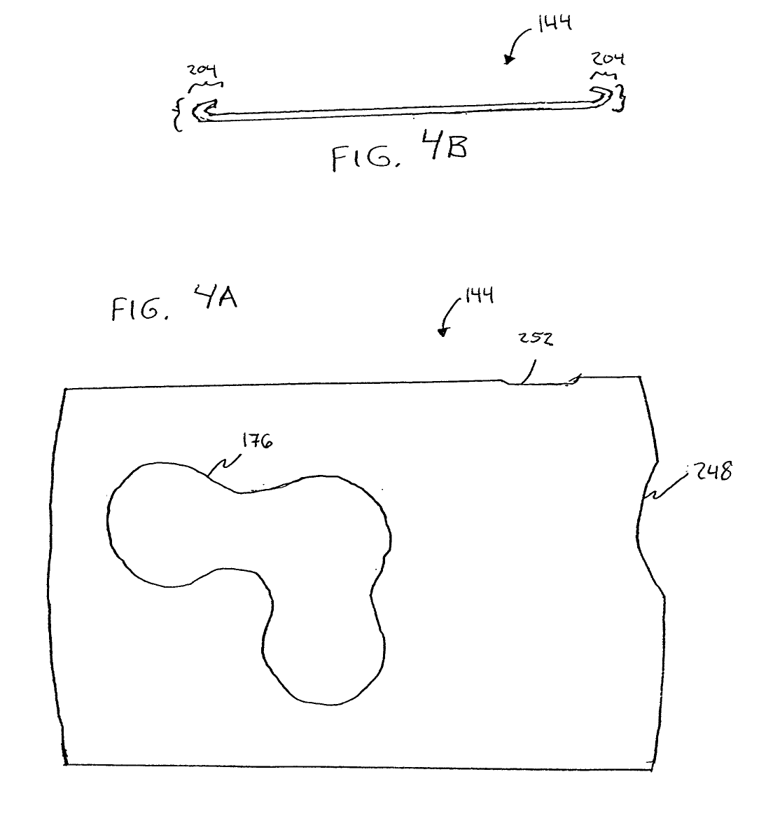

The front cover 140 and back cover 144 of the camera 124 are maintained in approximate parallel alignment using a tongue and groove mechanism. Although any fastening means may be used, the tongue and groove method construction advantageously provides a secure camera body using fewer parts and offering ease of assembly. FIGS. 5A and 5B illustrate an upper rail 192 and a lower rail 196, respectively. The upper rail 192 includes a groove 200 extending along its length to accept one lip 168 and 204 of the front cover 140 and the back cover 144, respectively. The lower rail 196 similarly includes a groove 208 along its length. The groove 208 accepts the other lip 168 and 204 of the front cover 140 and the back cover 144, respectively.

Referring again to FIG. 2A, the left end cap 212 and right end cap 216, in combination with the front cover 140 and the back cover 144, define the camera body and enclose the internal camera components. The end caps 212, 216 prevent the front and back covers 140, 144 from moving (i.e., sliding) along the rails 192, 196. The right end cap 216 is securely fastened to the one end of each of the upper and lower rails 192 and 196 by fastening screws 220 and 224, by way of through holes 228. The left end cap 212 is similarly fastened to the other end of each of the upper and lower rails 192, 196 with two screws (not shown).

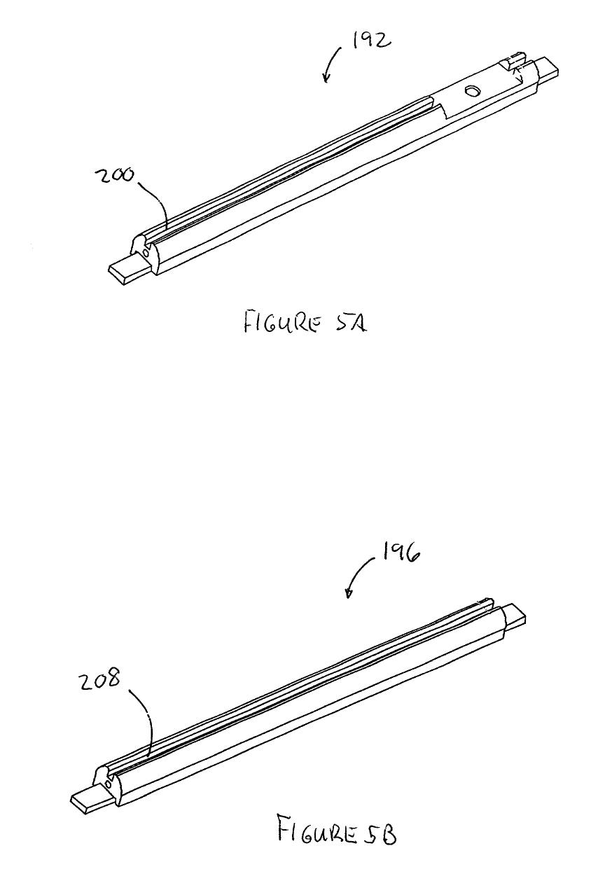

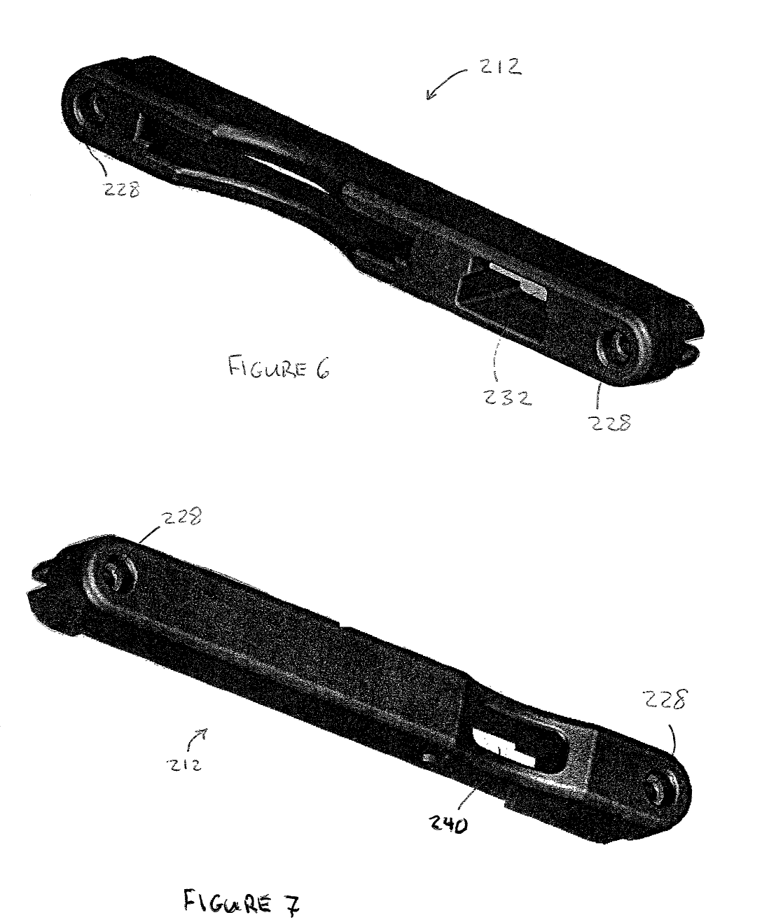

Referring to FIG. 6, the left end cap 212 includes an aperture 232 to accept a Universal Serial Bus (“USB”) format connector for downloading of images to a host computer or other remote host and charging the internal camera battery. The left end cap 212 also includes an aperture 236 to permit insertion or removal of portable storage media (e.g., a flash memory device). Referring to FIG. 7, the right end cap 212 includes an aperture 240 to accept a lens release button 244 (see FIG. 2A) or switch to release the lens holder 128 into its extended position for picture taking.

In the assembled camera, edge 248 is disposed adjacent to edge 152 in the front cover 140 to provide access to exchangeable components. Edge 252 is disposed adjacent to edge 156 in the front cover 140 to accommodate the shutter button 160. FIG. 2B illustrates the back side of the digital camera 124 of the embodiment shown in FIG. 2A, specifically illustrating the viewfinder eyepiece 138 positioned at a location corresponding to a viewfinder objective lens 136 location in lens holder 128 as described in detail below.

The front cover 140 and back cover 144 described above illustrate one embodiment of the invention. It should be understood that numerous variations to the covers 140, 144 are contemplated. For example, the edges 148 and 176 can be defined according to the locations of the lenses, buttons and switches, and internal components of the camera 124.

During picture taking, the user views the scene through the eyepiece 138 and depresses the shutter button 160 to initiate acquisition and storage of an image. The LCD status display 360 shows the current settings and status of the camera 124, including the number of additional images that can be acquired with the internal flash memory, the current image resolution (e.g., 640×480 pixel VGA format, 320×240 pixel QVGA format), camera sound status and remaining battery life.

The mute button 184 is used to activate or suppress a tone or beep which is available to alert the user to various operating conditions. For example, the tone or beep can be use to indicate when image acquisition is complete and when the camera is ready to capture another image. The picture size button 188 is used to define the effective image resolution of the images.

Referring again to FIG. 2A, in one embodiment the lens holder 128 is spring-biased to be in an extended position and includes an image taking lens assembly 132 and a viewfinder objective lens assembly 136. A user extends the lens holder 128 from the camera body 124 by pushing a lens release button 244 on the side of the camera body 124. The lens holder 128 extends, or pops out, from the camera body 124 due to spring-loading or some other mechanism, as described below.

The image taking lens assembly 132 is thereby positioned at a predetermined distance from an imager chip (not shown) to provide proper optical imaging. In one embodiment, this predetermined distance is the focal length of the image taking lens assembly 132. Similarly, the viewfinder objective lens 136 is positioned at a predetermined distance from a viewfinder eyepiece 138 to present a quality image to the user through the viewfinder eyepiece 138. The axis of the extension of the taking lens 132 and the axis of the extension of the viewfinder objective lens 136 in this example are each parallel with the camera optical axis as defined by the taking lens 132 and the imager chip. The lens holder 128 can retract into the camera body 124 such that its outer surface is substantially flush with the front cover 140 of the camera body 124. Manual retraction is accomplished by pushing the lens holder 128 into the camera body 124, with a catch mechanism provided to hold the retracted lens holder 128 in place.

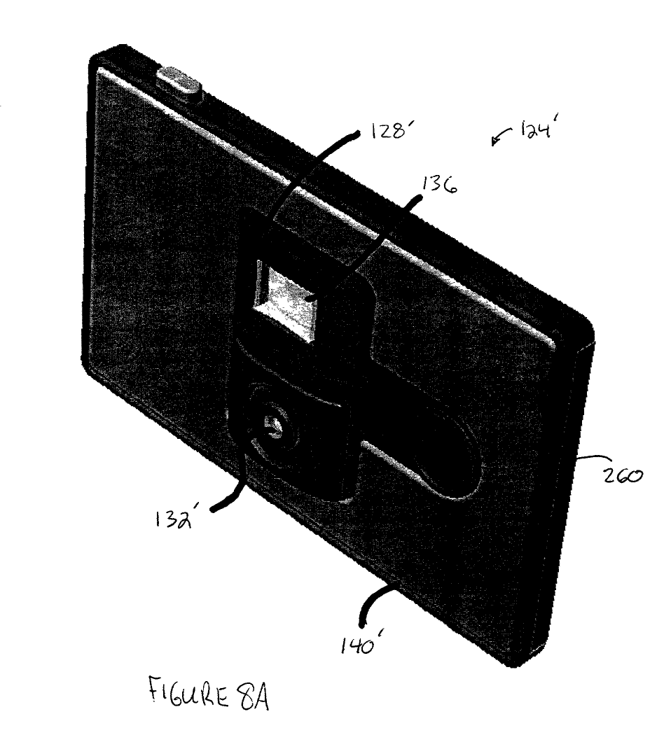

FIG. 8A illustrates another embodiment of a digital camera with a retractable lens holder 128′. In this embodiment the lens holder 128′ is spring-loaded such that it releases to extend from the camera body 124′ when a slidable lens cover 260 slides to the right along the camera front cover 140′. Referring to FIG. 8B, when the lens cover 260 is closed by sliding it to the left, the cover 260 pushes the lens holder 128′ into a retracted position, and optionally covers the lens holder 128′, thereby protecting both the taking lens 25 and the viewfinder objective lens 136. Preferably, the sides of the lens holder 128′ are beveled to enable sliding of the cover 260 over the holder 128′. It is further preferred that a mechanical lip be provided in the edge of the holder for preventing the edge of the cover from catching under the edge of the holder.

It is contemplated in accordance with the invention that in this embodiment the lens cover 260 can be manipulated over the lens holder 128′ in any convenient fashion, and thus is not limited to a sliding mechanism. For example, the lens cover 260 can be rotated or swung over and away from the lens holder 128′. It is preferred that appropriate beveling of the lens holder 128′ and appropriate mechanical lip configurations be provided to enable controllable movement of the cover 260 over the lens holder 128′.

In each embodiment when the lens holder 128 is in its extended position, the viewfinder objective lens 136 is spatially separated from the viewfinder eyepiece 138 by a requisite amount specified to enable eye relief during viewing and, if desired, to enable the appearance of photograph crop marks on the objective lens 136 when viewed through the eyepiece 138. Similarly, when the lens holder 128 is in its extended position, the taking lens 132 is spatially separated from the imager chip of the camera by a requisite amount specified to provide a quality image at the imager chip.

Whatever lens holder 128 and lens configuration is employed, the viewfinder eyepiece 138 can be provided as a transparent window fixed on or integral with the back cover 144 of the camera 124 as discussed above. The eyepiece 138 can be formed of, e.g., a glass, an acrylic material, Zeonex™, or other selected material.

Referring again to FIG. 2A, the taking lens 132 and viewfinder objective lens 136 are both preferably manufactured as integral features of the lens holder 128. In one example, the lens holder 128 is molded of, e.g., plastic, with the two lenses 132, 136 molded as integral features of the plastic body itself. The extent of each lens 132, 136 across the holder 128 is defined by the injection mold contour, e.g., with a relatively smooth surface provided at the location of each lens 132, 136. With this configuration, an opaque coating is provided on the lens holder 128 in the regions around the lens locations.

In a specific example of an integral lens-lens holder system, the lens holder 128 is injection molded of clear plastic such as Zeonex™ or acrylic. The holder regions surrounding the lens regions are provided with a textured surface that aids in the adhesion of a coating over those regions. An opaque coating is preferably provided on both the external and internal faces of the holder in regions surrounding the lens regions. The coating applied to the external face of the holder preferably is reflective, e.g., metallic, such that light is reflected from the holder 128, thereby inhibiting passage of light into the camera body 124. The coating applied to the internal face of the holder 128 can be reflective or opaque matte.

In an alternative configuration, the objective and taking lenses 132, 136 are molded or otherwise formed separately from the lens holder 128 and are then attached to the lens holder 128 in a suitable fashion. In one example, the lens holder 128 is manufactured as cast metal, plastic, or other selected material, and the lenses 132, 136 are held in place to the holder 128 by, e.g., spring-loaded fingers, or other features provided on the holder 128, the lenses 132, 136, or both. Press-fitting of the lenses 132, 136 into the holder 128 is not preferred due to a potential for lens distortion under pressure. Whatever lens attachment technique is employed, the lens holder 128 preferably is opaque, in the manner described above.

The invention does not require a single lens holder 128 for supporting both the objective lens 136 and the taking lens 132. In another embodiment the taking lens 132 and the objective lens 136 can each be provided in separate lens holders which can be extended and retracted separately. This configuration accommodates applications in which it is not required to extend both lenses 132, 136. This configuration also accommodates a design in which the taking lens 132 extends and retracts from the front cover 140 of the camera 124 while the viewfinder eyepiece 138, rather than objective lens 136, extends and retracts from the back cover 144 of the camera 124. In this scenario, a lens holder is provided for the taking lens on the front cover 140 of the camera 124, in the manner described above, and a similar eyepiece holder is provided for the viewfinder eyepiece 138 on the back cover 144 of the camera 124.

The invention further contemplates applications in which, for a given camera body design, the taking lens 132 is maintained in a fixed position, either extended or retracted, and the viewfinder objective lens 136 alone is provided in a lens body that extends and retracts. In this scenario, an extendable lens holder is provided for the objective lens alone, in the manner described above.

In still yet another embodiment the image taking lens 132 is fixed in place, and the viewfinder eyepiece 138, rather than the viewfinder objective lens 136, can be extended and retracted. In such a configuration, a viewfinder eyepiece holder can be provided on the back cover 144 of the camera 124 in a manner similar to that described above with reference to the front cover 140 of the camera 124.

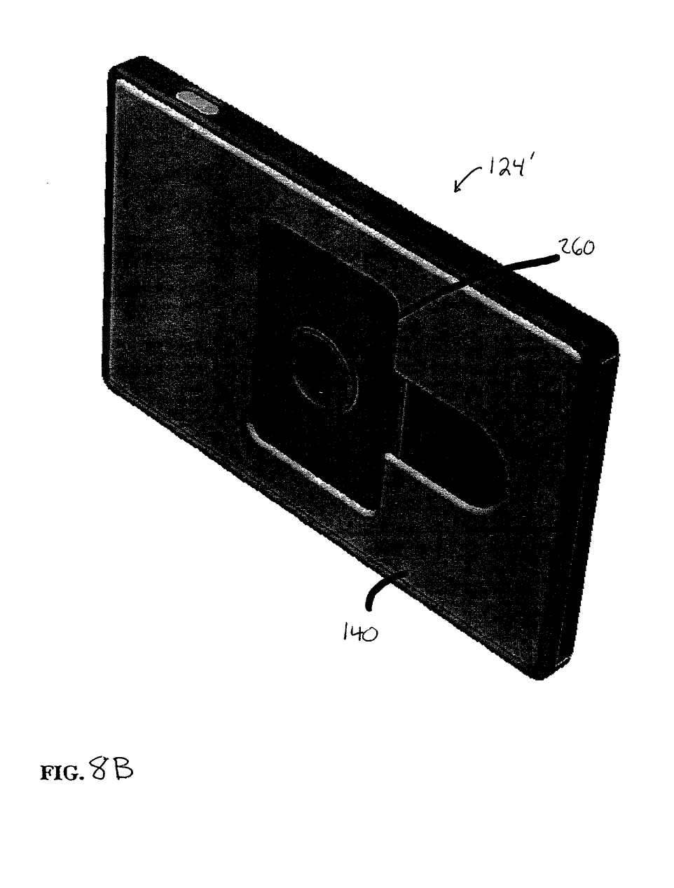

It is recognized in accordance with the invention that for applications in which the taking lens 132 is maintained in a fixed position, such can be produced by bonding the taking lens 132 to the camera imager chip package. Referring to FIG. 9, in this scenario, the taking lens 132 is bonded to the package 264 in which the imager chip 268 is provided. This results in the taking lens 132 itself functioning as a transparent package lid. This configuration can be particularly advantageous in that it fixes the spatial relationship between the taking lens 132 and the imager chip 268 rather than between the taking lens 132 and the camera body 124. With the lens 132 automatically referenced to the image plane, rather than the camera body 124, no particular physical adjustment or calibration is required from camera to camera during manufacture.

The invention further contemplates applications in which only the taking lens 132 is to be extended and retracted, with the viewfinder objective lens 136 and eyepiece 138 fixed in place on the camera body 124. In this scenario, the viewfinder objective lens 136 and eyepiece 138 can each be provided in any suitable configuration, e.g., in a conventional manner as molded pieces, as a liquid crystal display, or in another selected configuration fixed on the camera body 124. An extendable lens holder is supplied for the taking lens 132 in the manner described above.

In yet another embodiment of the invention the taking lens 132 is extendable to a first position from the camera body 124 and the viewfinder objective lens 136 is extendable to a second position. In one such embodiment, both the taking lens 132 and the viewfinder objective lens 136 are positioned according to a first activated position of a common lens holder. One of the lenses 132, 136 is then extended to a second position by a single release mechanism integrated into the common lens holder. This configuration has the advantage of accommodating a taking lens 132 and a viewfinder objective lens 136 specified for different working separations from the imager chip 268 and the viewfinder eyepiece 138, respectively.

In an alternative embodiment the taking lens 132 is maintained fixed with respect to the front cover 140 of the camera body 124 and the imager chip 268 and chip package 264 are extendable from the back cover 144 of the camera body 124. In this embodiment, the electrical connections from the imager chip 268 to internal camera circuitry can be flexible or compliant to permit operation of the imager chip 268 in the extended position. Advantageously, this embodiment reduces the risk of contact with the taking lens 132 that is present in configurations in which the taking lens holder is depressed to extend or retract the taking lens 132. In a further embodiment the taking lens 132 is extendable from the front cover 140 of the camera body 124 and the imager chip 268 and chip package 264 are extendable from the back cover 144 of the camera body 124. This configuration achieves a greater taking lens to imager chip separation than that possible if only one component is extendable.

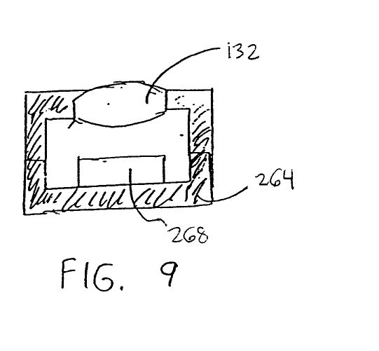

Referring now to FIG. 10, there is shown an embodiment of a lens holder spring-loading mechanism in accordance with the invention. In this example, leaf springs 272 are provided for biasing the lens holder in a “normally extended” position. The leaf springs preferably are formed of material that can be soldered to the camera's printed circuit board on which the imager chip and associated electronics is provided; in one example, hardened copper leaf spring material is employed. It is preferred that a guide track or other feature be provided on the lens holder for controlling the location of the leaf springs as the holder is pressed into place on the springs, and for attaching the leaf springs to the holder.

This leaf spring design is advantageous for some applications in that it requires only two solder joints to form four springs, two from each material piece. This design may not be desirable for some applications, however, in that for some configurations the leaf springs may accommodate a small degree of rocking of the lens body on the springs, whereby the taking lens may be moved out of a selected focal plane. In other embodiments the leaf springs can be riveted to the printed circuit board. Such a design is preferable for leaf springs fabricated from materials that cannot be soldered. This rocking condition is also enabled by an alternative spring configuration in which a small coil spring is connected between each corner of the lens holder and the printed circuit board. Nevertheless, the invention contemplates applications in which such spring connectors are employed; if minor movement of the taking lens is acceptable for a given application, such leaf and coal springs can be preferable for their simplicity of manufacture.

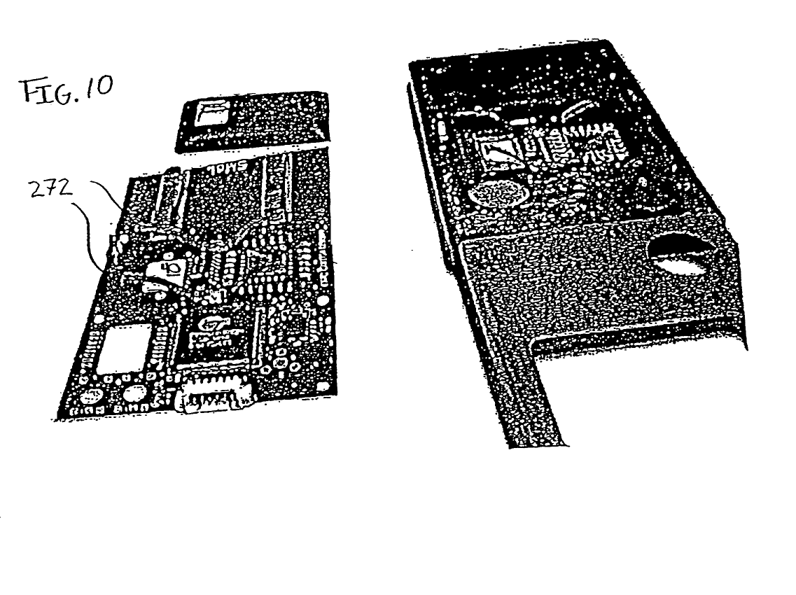

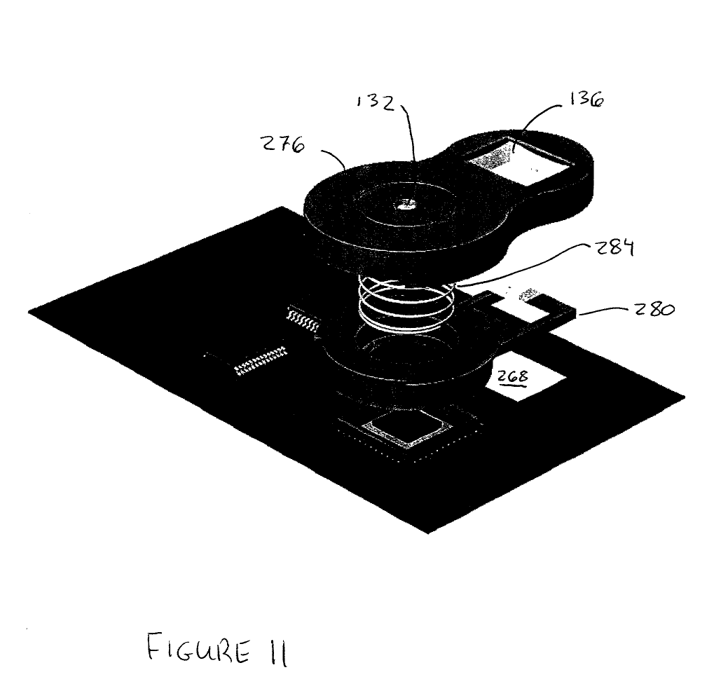

Another embodiment of a lens holder spring bias mechanism is illustrated in FIGS. 11-14. As shown in FIGS. 11 and 12, the lens holder here includes an upper lens holder 276, which includes the taking lens 132 and the objective lens 136, and a lower lens holder 280 which includes apertures corresponding to the location of the taking lens and the objective lens. As discussed above, the invention does not require the inclusion of both the objective and taking lens in the lens holder; such is shown here only for illustration. Preferably, the lenses are held against the upper holder by, e.g., leaf springs, or by another suitable bias support. The lower lens holder 280 is fixed to the printed circuit board in the vicinity of the camera imager chip 264, or more preferably, is bonded directly to the imager chip 264 to ensure that the taking lens 132 is fixed with respect to the imaging plane and need not be fine tuned from camera to camera during manufacture.

A bias spring 284 is provided between the upper and lower lens holders 276, 280, connected to one or both holders. The bias spring 284 is provided with a diameter that is greater than the width of the imager chip 264, such that the spring 284 resides outside of the periphery of the chip 264. Because the viewfinder is optically forgiving, there is no need to precisely reference the lens holder to the viewfinder eyepiece 138. It is therefore preferred that the bias spring 284 be positioned at the location of the taking lens 132, rather than the objective lens 136, to maintain precise positioning of the taking lens 132 with respect to the imager chip 264. It is of course desirable that the objective lens 136 in the upper lens holder 276 and the corresponding aperture in the lower lens holder 280 be aligned with a printed circuit board aperture 288 located for alignment of the objective lens with the viewfinder eyepiece 138.

As shown clearly in FIG. 12, in one example configuration, the upper and lower lens holders 276, 280 each include stops 292, 296, respectively, that mate, for connecting the upper lens holder 276 in place against the lower lens holder 280. For the example mating stops shown, the upper lens holder 276 is turned 90° to the lower lens holder 280, pressed in place, and then turned back 90° to connect the two together. This example of a lens holder assembly system is not meant to be limiting; the invention contemplates a wide range of assembly systems, and it is preferred that the selected system, like that described just above, enable precise positioning.

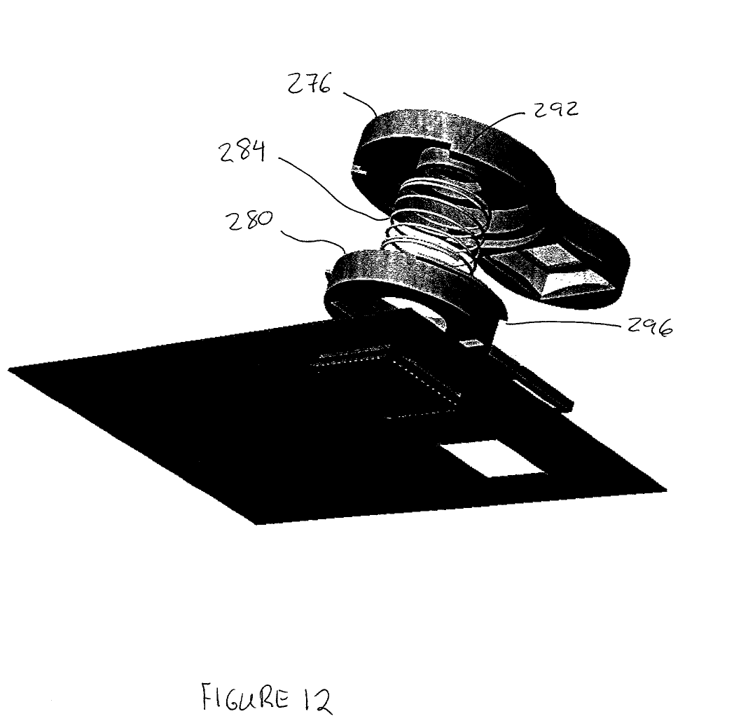

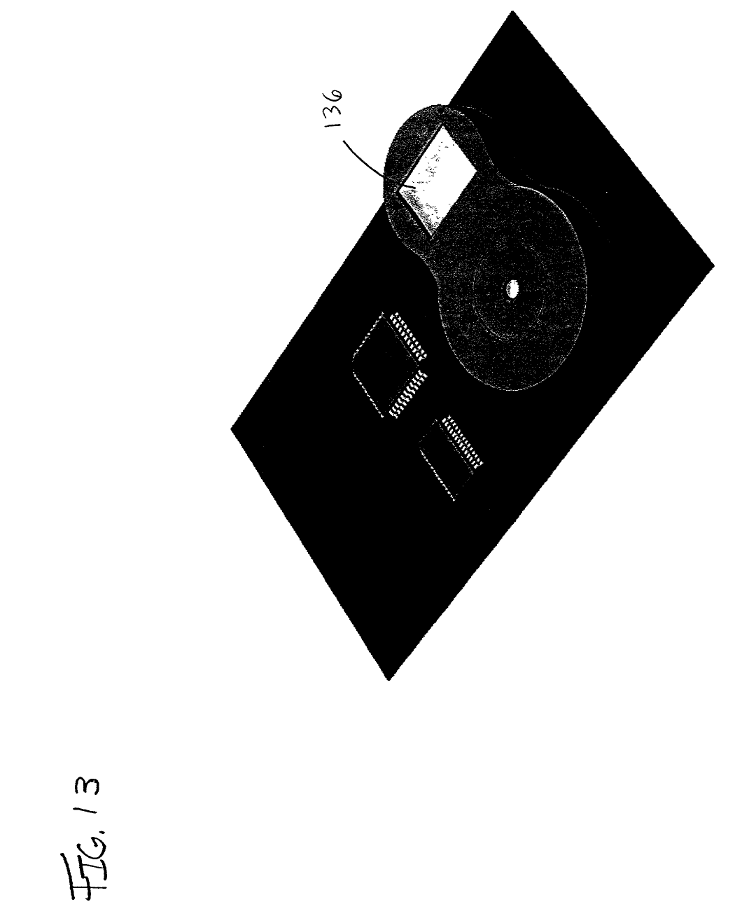

FIG. 13 illustrates the assembled configuration in a condition where the spring 284 is enabled to release to push the upper lens holder upward against the mating stop 296 of the lower lens holder 280, and thereby to extend the upper lens holder 276 from the camera 124. This condition can be produced by, e.g., moving a slide plate from covering the holder, in the manner of the example shown in FIGS. 8A and 8B; or in any suitable alternative configuration, including, e.g., a latch or other holding mechanism. FIG. 14 illustrates a condition in which the upper lens holder is extended, in an example configuration in which a latch is employed to extend the lens holder.

Note in FIG. 13 that the wall of the lower lens holder 280 surrounding the aperture for the imager chip 268, in conjunction with the wall of the upper lens holder 276 surrounding the taking lens 132, acts as a light shield, inhibiting light from passing from the viewfinder objective lens 136 to the imager chip 268 when the upper lens holder 276 is extended. It is preferred in accordance with the invention that for any lens holder configuration, some light shield be included to provide this function, e.g., by employing a single wall, a pair of oppositely positioned walls, or other light shielding feature.

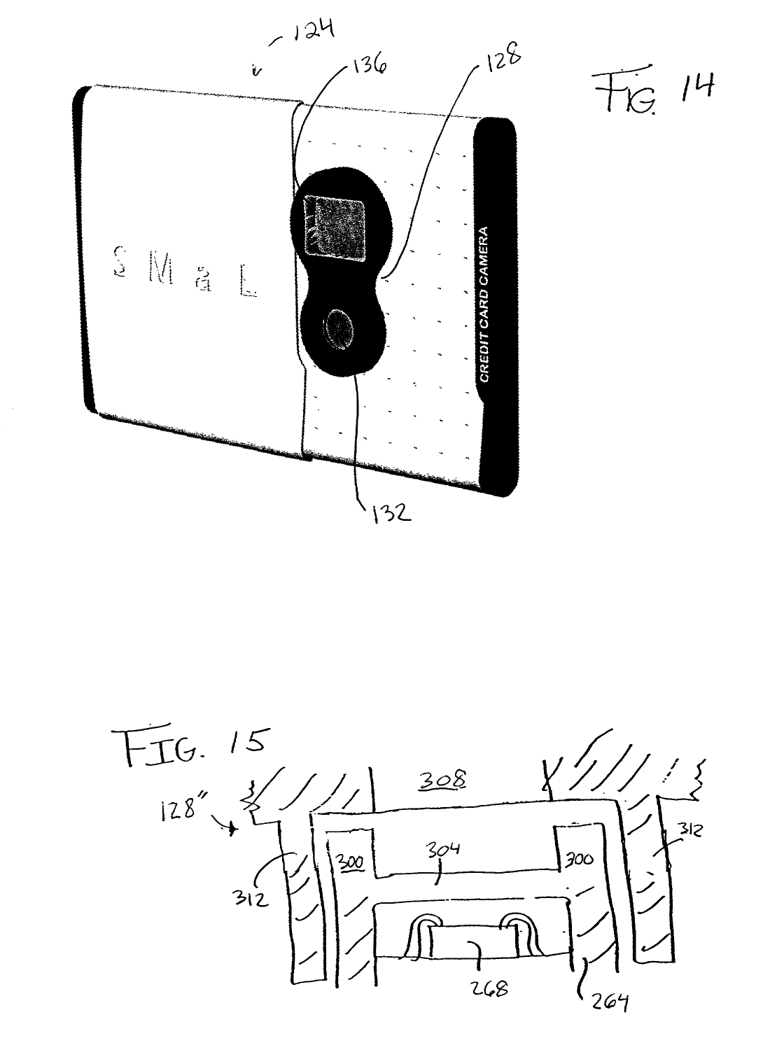

Referring to FIG. 15, there is shown schematically an example of a general arrangement provided by the invention for enabling a light shield around an imager chip 268. The imager chip 268 is provided in a package 264, having walls 300 that are opaque. A transparent package cover 304 is optionally provided over the chip 268. The lens holder 128″ includes a transparent region 308 for the taking lens 132, surrounded by opaque regions. Attached to the lens holder 128″ are light shield walls 312 corresponding to the chip package walls 300. The heights of the chip package walls 300 and the lens holder walls 312 are selected together such that when the lens holder 128″ is in a position of maximum extension, light from the viewfinder objective lens 136 is blocked by one of the walls.

In a further embodiment of a spring bias mechanism, a threaded screw-like member and turn wheel are provided for extending a lens holder from the camera body 124. Here a turn wheel on the front or back of the camera 124 mates with screw threads. Threads can be provided with engaging stop features for setting the maximum lens holder extension. Alternatively, a spring can be connected between the screw and the turn wheel, preferably with a stability points designed in the spring for setting the maximum extension and for setting the retracted position.

It is contemplated by the invention that the lens holder extension operation be motorized. In one example configuration enabling this, a coil to which current can be applied is provided attached to the lens holder 128, and a permanent magnet is fixed to the camera body 124 or printed circuit board. Application of a current to the coil produces a magnetic field and corresponding force that pushes the coil away from the permanent magnet, resulting in extension of the lens holder. Activation of the current is initiated by, e.g., sliding of the protective cover, or other activation technique. The invention is not limited to a magnetic linear motor, and contemplates motorization of lens holder extension in general.

In a further embodiment of a lens holder extension technique, a button is provided on the back of the camera 124. The button is a fixed mechanical extension of the lens holder spanning the thickness of the camera 124, and located at the periphery of the printed circuit board or through an aperture provided in the printed circuit board. Pressing of the button at the back cover 144 of the camera 124 results in extension of the lens holder. Pressing of the lens holder itself results in retraction of the lens holder back toward the camera body 124. As discussed above, this example does not require the inclusion of a lens cover. However, if desired, a lens cover can be provided that slides or swings over the lens holder once the lens holder is retracted into the camera body.

In still yet a further example of a lens holder extension technique, a sliding wedge is provided in the camera body, with a slide member connected to the wedge and accessible at, e.g., the back cover of the camera 124. The wedge includes, e.g., two rails that correspond to rails provided on the internal face of the lens holder. Sliding of the wedge under the rails of the lens holder extends the lens holder away from the camera body 124. Given a rail on two opposing sides of the lens holder, rocking of the lens holder is substantially inhibited.

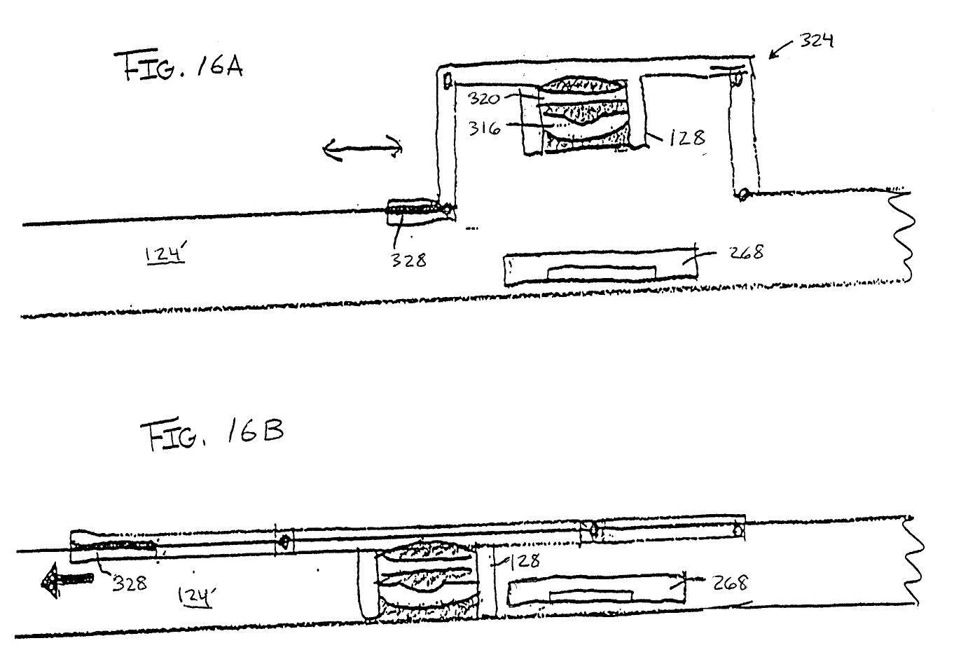

FIGS. 16A and 16B illustrate a further lens holder mechanism and extension/retraction technique. In this configuration, there is provided a lens holder 128 that can accommodate multiple element lens assembly including lenses 316, 320. The use of multiple element, and optionally glass, lenses in this lens holder arrangement enables correction of optical distortion and color dispersion, and enables increased optical resolution. The lens holder 128 is supported by a pivoting linkage 324, one arm 328 of which is slidably mounted along a track provided on the camera body 124′. The camera body wall is open in the region under the pivoting linkage 324.

FIG. 16A illustrates the arrangement when in the extended position. To retract the arrangement, to the position shown in FIG. 16B, the tracked linkage arm 328 is slid to collapse the linkage 324 and retract the lens holder 128 into the camera body to a location adjacent the imager chip 268. In this position, the linkage 324 acts as a mechanical protective cover that extends across the opening of the camera body 124′. Extension of the arrangement is then enabled by sliding the tracked linkage arm 328 back to its first position shown in FIG. 16A. This embodiment illustrates that the retraction mechanism of the invention can move the lens holder 128 both laterally and perpendicular to the camera body, and can locate the lens holder 128 at a position within the camera 124′ that is adjacent to, rather than in line with, the imager chip 268.

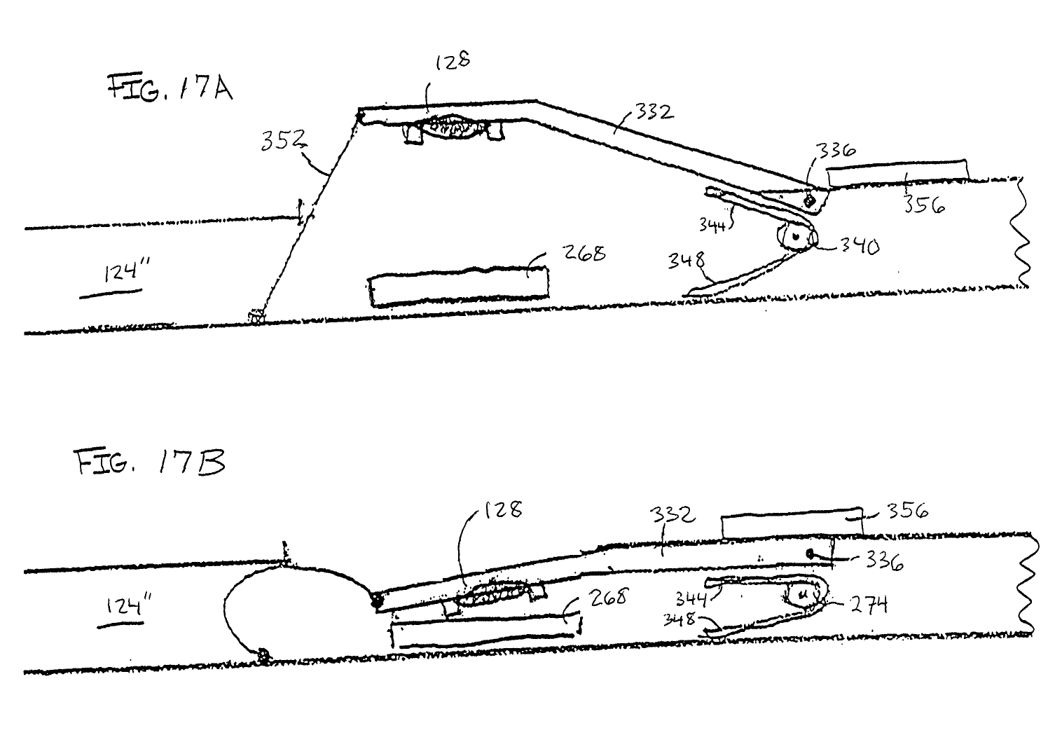

FIGS. 17A and 17B illustrate a further lens holder 128 and extension/retraction mechanism. Here the lens holder 128 is a first end portion of a ramp arm 332. The ramp arm 332 pivots about an end pivot point 336. At the location of the pivot point 336 there is provided a turn spring 340 having arms 344, 348 that are biased against the ramp arm 332 and the back of the camera body 124″, respectively. The front of the camera body 124″ is open under the lens holder 128 and the ramp arm 332.

In other embodiments, a flexible light shield 352 may be provided at the end of the lens holder 128 to shield the camera 124″ when the lens holder 128 is in the extended position as shown. The shield can be provided as, e.g., mylar, ABS plastic, or other suitable material, preferably provided as opaque black.

To retract the lens holder 128 to the position shown in FIG. 17B, the ramp arm 332 is pushed into the camera body 124″. This can be accomplished by, e.g., moving a sliding cover 356 over the ramp 332, or by simply manual pressure against the ramp 332. Retraction of the ramp arm 332 retracts the lens holder 128 into the camera body 124″ and collapses the light shield 352 into the camera body 124″.

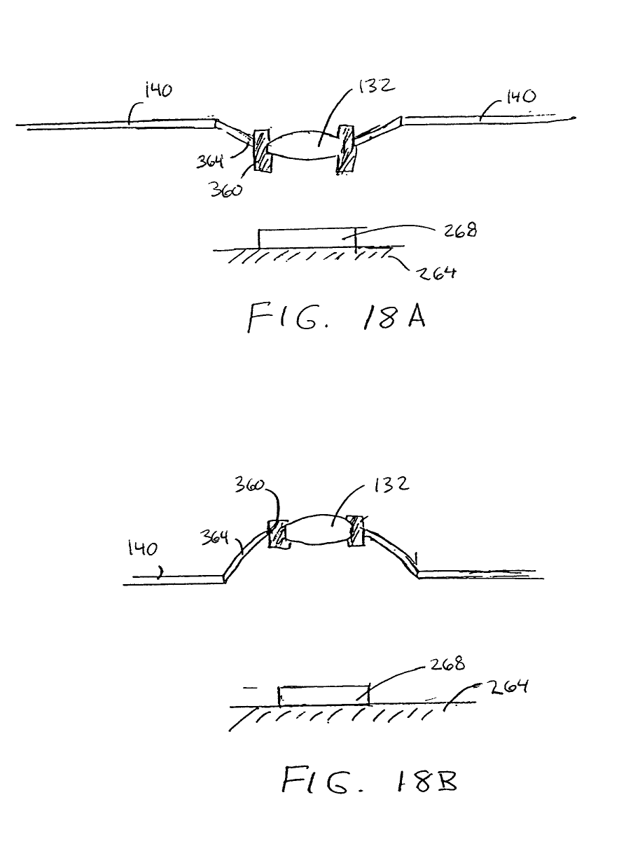

FIGS. 18A and 18B illustrate still yet another lens holder embodiment and extension/retraction technique. Referring to FIG. 18A, a taking lens holder 360 secures one or more elements that comprise the taking lens assembly 132. The taking lens holder 360 is secured to a dome switch 364 shown in the retracted position. The dome switch 364 includes a bistatic surface having two or more stable configurations or positions. The bistatic surface can be fabricated, for example, from spring tempered stainless steel or other material having a shape that provides the two stable configurations or positions. Pressure is applied by the user to the dome switch 364 to move the taking lens 132 and holder 360 from the retracted position to a stable extended position as depicted in FIG. 18B. In a further embodiment, a dome assist mechanism is provided between the camera surface and the bistatic surface of the dome switch 364, and is adjacent to the imager chip 268. The assist mechanism can provide additional pressure to the bistatic surface to boost the taking lens 132 to the extended position.

In alternative embodiments, the dome switch 364 is replaced by other resilient structures having at least two stable configurations. Such structures can be fabricated from various materials that change from one geometric shape to another, thereby repositioning the taking lens 132 in a second stable position. Preferably the switch is fabricated from opaque materials to prevent stray light from reaching the imager chip 268. It should be recognized that the application of the dome switch 364 for extension and retraction is not limited to the taking lens 132. Alternatively, the dome switch 364 can be used to extend and retract the viewfinder objective lens 136, the viewfinder eyepiece 138 or the image chip 268 and chip package 264.

The examples described above and illustrated in the accompanying drawings are provided to demonstrate the breadth of mechanisms that enable the extension and retraction of digital camera lenses such that in operation, the distance between the imager chip 268 and the taking lens 132 of the camera is greater than the thickness of the camera 124. Similarly, in combination or separately, the distance between the view finder eyepiece 138 and viewfinder objective lens 136 is greater than the thickness of the camera 124. As such the mechanisms are not limited to the arrangement of the earlier examples above in which the axis of lens holder extension and retraction is orthogonal to the camera body length and width. Other embodiments are possible in which the lens holder can be extended from the camera body by swinging the holder in an arc from a retracted position, to a retracted position that is either in line with or adjacent to the imager chip. In this scenario, the axis of lens holder extension is not parallel with the optical axis of the camera. It is thus to be recognized that the invention does not require the lens holder extension and retraction to be in a particular direction or along a particular axis.

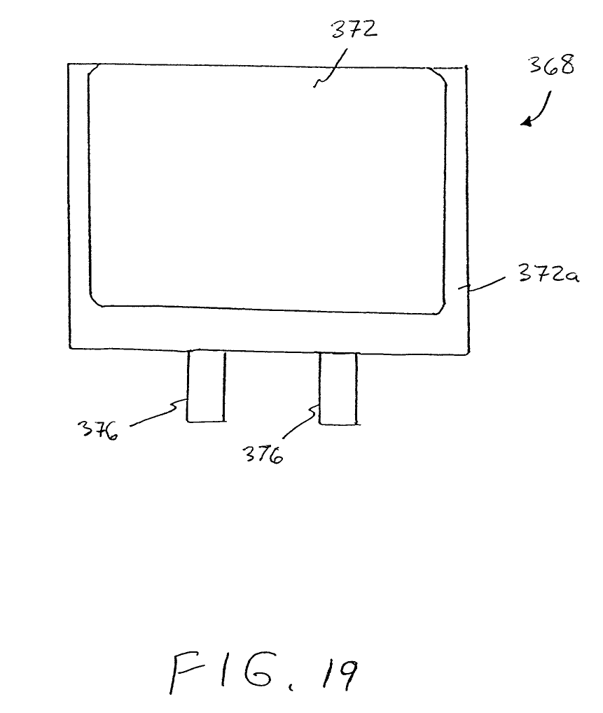

FIG. 19 illustrates a power source suitable for use in the camera. The power source may be any suitable power source, such as a battery, meeting camera power requirements and having a form factor allowing for installation within the camera body 124. In one embodiment the power source is a rechargeable battery 368, such as a lithium polymer battery 368, having a long useable life. The battery 368 includes a battery body 372 comprising a single leaf and two thin and flat nickel-plated terminals 376. The terminals 376 conduct current to the electrical components of the camera 124. In the illustrated embodiment the terminals can have a width of 3 mm or less and be 8 mm in length. The battery body 372 comprises a laminated pouch (sealed along region 372a) sized to accommodate the form factor of the camera body 124. The leaf 372 can have a thickness of 1 mm or less and the total battery weight can be 2 g or less.

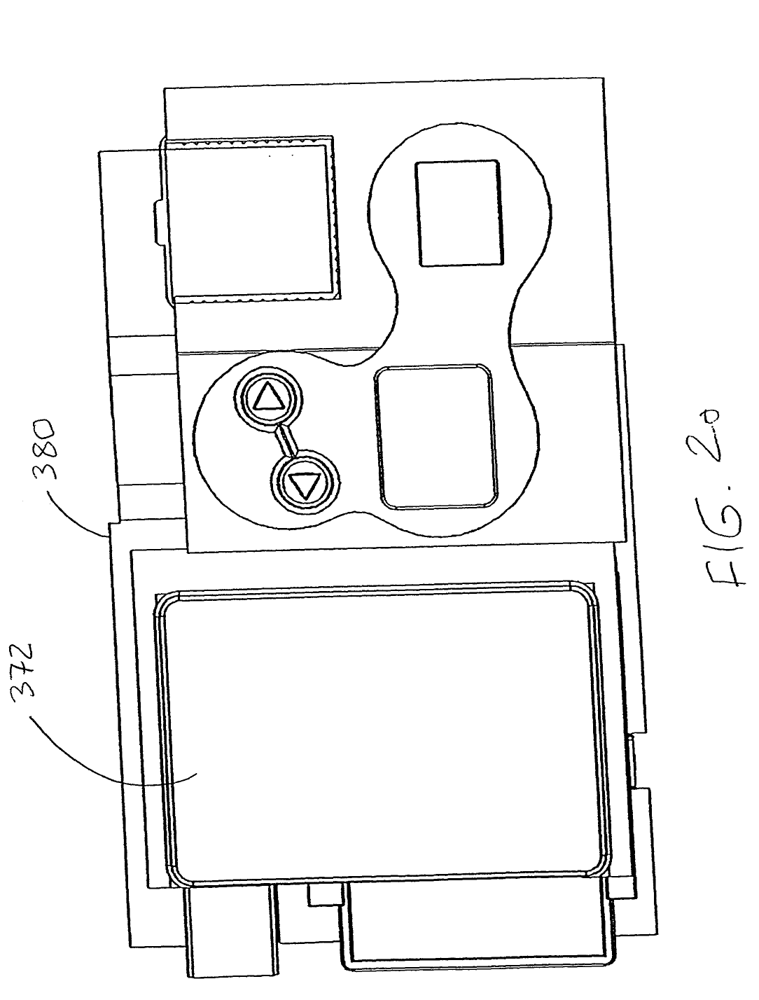

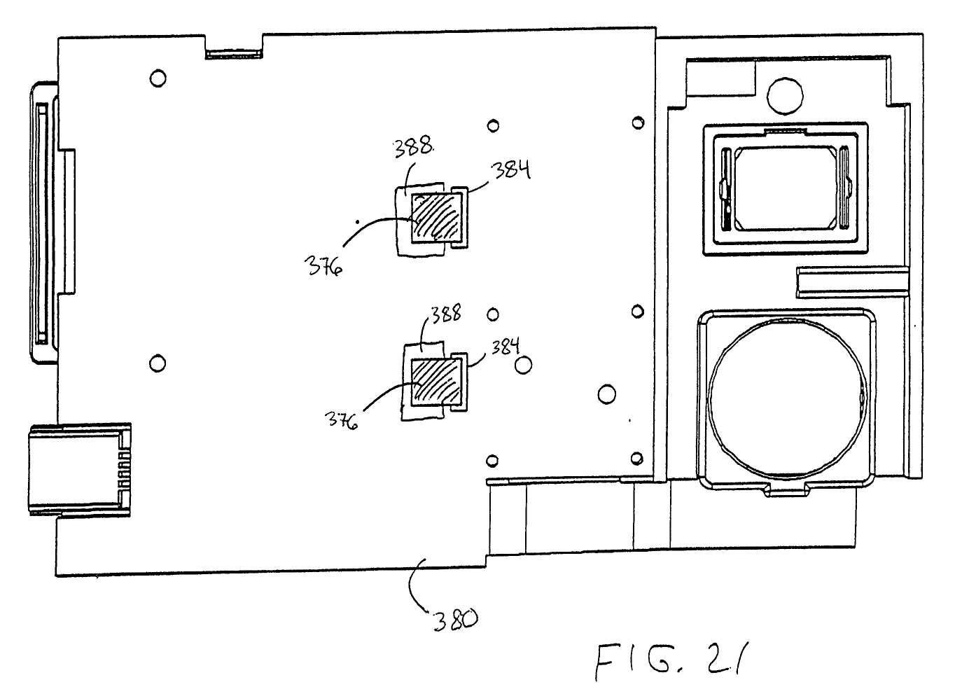

In one embodiment the rechargeable battery 368 is permanently mounted inside the camera body 124 such that the plane of the battery body 372 is parallel and adjacent to the component side of a camera printed circuit board 380 as shown in FIGS. 20 and 21. The two terminals 376 extend from the component side to the underside of the printed circuit board 380 through two slots 384. In the illustrated embodiment the slots 384 are non-conductive to avoid interference with the current conducted through the terminals 376 although, in other embodiments, the slots or apertures can be conductive to provide a direct electrical path between the component side and the underside of the printed circuit board. After passing through the slots 384, the conformable terminals 376 are folded to permit soldering or welding to conductive pads 388 on the underside of the circuit board 380. The bonded terminals 376 provide an electrical connection to the internal circuitry and rigid mechanical support for the battery body 372.

As shown in the drawings for the purposes of illustration, the power subsystem 116 portion of the invention is embodied in circuits that (i) select the proper power source for the camera while maintaining proper isolation between the power sources, (ii) charge the lithium ion (“Li”) battery in a predetermined fashion using an adjustable constant current- constant voltage scheme, and (iii) arbitrate between various power states to minimize power dissipation, thereby extending the duration of operability between recharging or replacement of the power source. A power management subsystem according to the invention ensures the efficient use of the Li battery and protects the camera circuitry from an improper connection between the multiple power sources. The power management subsystem minimizes power consumption during all time and modes of operation and enables the use of a smaller power source than would otherwise be required. In particular, the power management subsystem enables use of the Li battery, which in turn has a form factor allowing it to be self contained within the credit-card-sized camera.

The digital camera includes a Li battery (typically one cell) as a power source. When the camera is not docked to a personal computer (“PC”) via the USB, the Li battery provides the necessary energy to power the camera electronics. When the camera is docked via the USB, the camera (i) obtains operational power from the USB, and (ii) uses the power available from the USB to charge the Li battery. A USB typically provides as much as 500 milliamperes at 5.25 V.

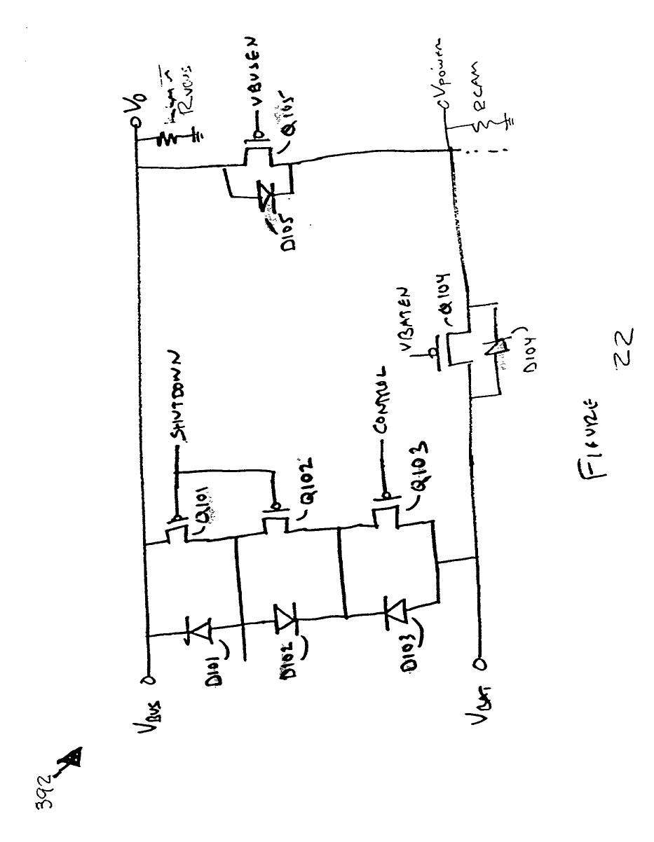

To avoid damage and improper cross connections between the USB and the Li battery, the camera includes circuitry that, on the basis of control signals, connects the Li battery to, or isolates it from, the camera electronics. The circuitry prevents a simultaneous connection of both the PC USB and Li battery to the camera electronics. In brief overview, FIG. 22 shows such selection-isolation circuitry 392. V_{POWER} represents the power bus for the camera electronics (denoted by “RCAM”). V_{POWER} derives its power from either the Li battery or the USB connection to a PC. Logic signals V_{BATEN}, V_{BUSEN}, CONTROL, and SHUTDOWN, as described below, direct the selection-isolation of the power sources.

Field effect transistors (“FETs”) Q104 and Q105 perform the selection-isolation. This is understood by examination of the following truth table, where V_{POWER} represents the voltage presented to the camera electronics:

| V_{BATEN} | V_{BUSEN} | Q104 | Q105 | V_{POWER} |
|---|---|---|---|---|
| 1 | 0 | OFF | ON | V_{BUS} |
| 0 | 1 | ON | OFF | V_{BAT} |

When battery operation is desired, V_{BATEN} is set to a logic low and V_{BUSEN} is set to a logic high. This turns Q104 on and Q105 off. Diodes D104 and D105 are the parasitic diodes formed in association with Q104 and Q105, respectively. Current flows from the Li battery (connected to V_{BAT}), through Q104 and into V_{POWER} Because FET Q104 is on, however, current does not flow through diode D104. In this configuration, the battery is powering the camera electronics RCAM and, with Q105 off, the orientation of D105 blocks current from flowing into V_{BUS}.

Conversely, when V_{BATEN} is set to a logic high and V_{BUSEN} is set to a logic low, Q105 is turned on and Q104 is turned off. Although the bus current can pass through Q105, it cannot pass through D104 into V_{BAT}. In this instance, the camera electronics RCAM receives power from V_{BUS}, which is typically connected to the PC USB, and D104 blocks the current from flowing into V_{BAT}.

In each instance described above, the parasitic diodes are oriented such that they (i) block current from flowing around a FET that is off, and (ii) are shunted by a FET that is turned on, thereby avoiding forward bias. By avoiding this forward bias condition, excessive parasitic current is prevented which, for example, prolongs battery life.

During battery charging, current flows from V_{BUS} (connected to the PC USB) into the battery via the network of FETs Q101-Q103. Logic signal SHUTDOWN is set to a logic high to discontinue charging. As discussed below, the CONTROL signal (an analog signal) is adjusted to vary the amount of current flowing into the battery for charging.

The following truth table details the operation of Q101 and Q102 in response to the SHUTDOWN and CONTROL signals:

| SHUTDOWN | Q101 | Q102 |
|---|---|---|
| 0 | ON | ON |
| 1 | OFF | OFF |

When SHUTDOWN is set to a logic high, FETs Q101 and Q102 turn off and D102, irrespective of the state of the CONTROL signal, stops battery current from flowing from V_{BUS} to V_{BAT}. This would typically occur when the battery is providing power when SHUTDOWN is set to a logic high. Similarly, D101, which is reversed biased relative to V_{BUS}, prevents USB current from flowing from V_{BUS} to V_{BAT}. This would be the case where the PC USB is providing power when SHUTDOWN is set to a logic high.

When SHUTDOWN remains low, FETs Q101 and Q102 shunt the associated parasitic diodes D101, D102, avoiding a forward bias condition, and act as a short circuit between V_{BUS} and FET-parasitic diode pair Q103-D103. This provides a complete path between V_{BUS} and V_{BAT} through Q103, thereby allowing Q103 to CONTROL the current flowing from V_{BUS} into V_{BAT}. Consequently, as the CONTROL signal is varied from low to high, the amount of current flowing from V_{BUS} to V_{BAT} (i.e., the battery charging current) can be adjusted from a maximum value to a minimum value. Specifically, when CONTROL is at a minimum value, FET Q103 is on, effectively shunting diode D103 and allowing the current to flow from V_{BUS} to V_{BAT}. When CONTROL is at a maximum value, Q103 is off and D103 blocks this current flow. A closed loop feedback system determines the CONTROL signal such that the amount of current delivered through Q103 into V_{BAT} is typically what is needed for proper battery charging at any given moment.

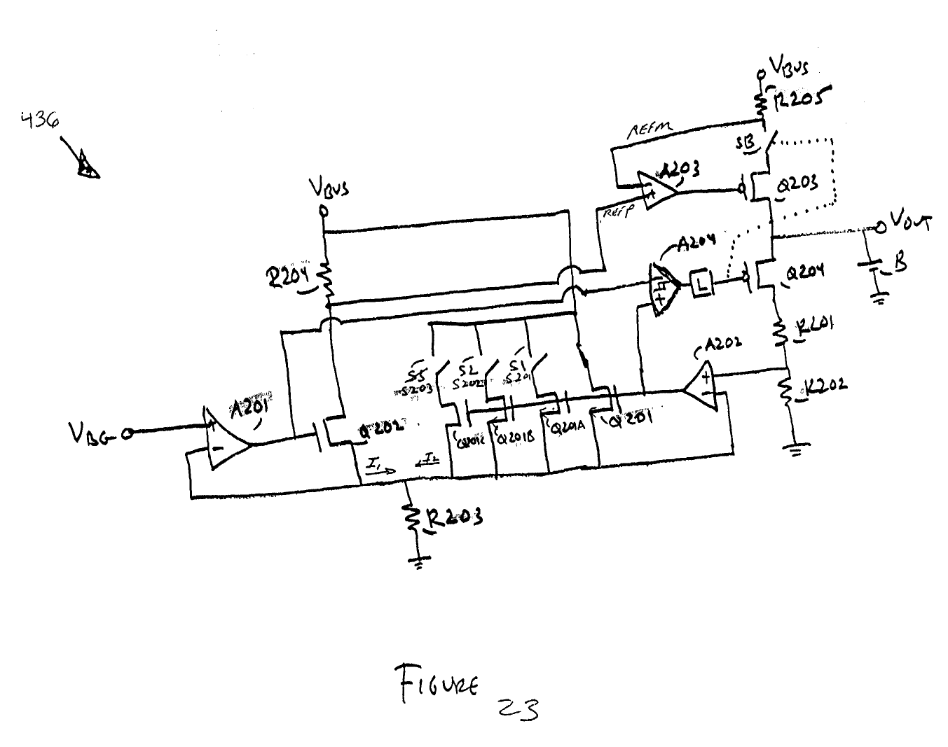

FIG. 23 is a simplified schematic representation of the Li battery charging circuit 436. An objective of this circuit is to set the value of the CONTROL signal, which in turn adjusts the amount of charging current provided to the battery. To simplify discussion, all operational amplifiers (“opamps”) appearing in FIG. 23 are modeled as “ideal.”

By way of background, Li batteries are charged using a constant current- constant voltage (“CCCV”) method. During a first charging phase, the circuit provides the (discharged) battery with a constant current, typically about thirty milliamperes, until the battery terminal voltage reaches about, for example, 4.2 V. At that point, a second charging phase begins where the circuit provides a constant voltage (e.g., 4.2 V) and allows the current to decrease asymptotically. After a further period in this phase, the battery is deemed charged. The circuit of FIG. 23 performs CCCV charging and allows adjustments to be made to the charging method by modifying camera firmware.

As shown in FIG. 23, V_{BG} is a bandgap reference voltage, typically 1.25 V. V_{BG} is connected to the non-inverting input of opamp A201. Values for the resistors R201 and R202 in the voltage divider are chosen such that the voltage across R202 is substantially equal to V_{BG} when the terminal voltage of battery B is substantially equal to the fully charged value (i.e., 4.2 V). The voltage across R202 appears at the non-inverting input of A202. By virtue of its connection to the inverting input of A201, the current flowing through R203 is equal to V_{BG} divided by R203. (This is termed the bandgap reference current.) In other words, R203 may be replaced by a current source with constant value V_{BG}÷R203. The amount of current flowing through Q202 and Q201 will sum to this value, but their relative magnitudes will vary, as discussed below.

Assuming the battery B is discharged (i.e., has a terminal voltage of less than 4.2 V) and the SHUTDOWN signal is set to a logic low, the voltage across R202 is less than V_{BG}. This drives the output of A202 low (turning off Q201). The outputs of A202 and A201 are connected to the non-inverting and inverting inputs, respectively, of comparator A204. At the start of the charging cycle, the output of latch circuitry L is set to logic low. Consequently, Q204 turns on and switch SB is closed.

In this state, the total bandgap reference current through R203 (an external resistor of approximately 50 kohms) flows from V_{BUS} through R204 and Q202. Signal REFP, associated with the voltage drop across R204, is connected to the non-inverting input of A203. Additionally, signal REFM, associated with the voltage drop across R205, is connected to the inverting input of A203. R204 and R205 (modeled as resistive elements) are typically fabricated from NMOS FETs. R205 has approximately one thousand times greater resistance than R204. Because of this difference in resistance, the current flowing through R205 is approximately one thousand times greater than that flowing through R204. Signal REFM provides negative feedback to A203 such that the output of A203 is driven to cause signal REFM to equal signal REFP. Consequently, the output of A203 controls the current flowing through Q203 such that the voltage drops across R204 and R205 are equalized. During this time, a constant battery charging current flows to the battery from V_{BUS} through R205, SB, and Q203. This is the first charging phase described above.

As the battery terminal voltage approaches its final value (4.2 V), the voltage at the non-inverting input of A202 begins to approach V_{BG} and the output of A202 begins to go high. This turns on Q201, which sinks additional current into R203. This additional current eventually causes the voltage at the inverting input of A201 to rise to or slightly above V_{BG}, causing the output of A201 to decrease, thereby reducing the amount of current through Q202 and R204. Consequently, the voltage at the non-inverting input of A203 begins to rise. This causes A203 to reduce the amount of current flowing through Q203 (and R205). A result is constant voltage regulation, wherein any increases in battery terminal voltage cause a reduction in current. This is the second charging phase described above.

The value of the outputs of A202 and A201 in the second charging phase causes the output of A204 to be driven high as soon as the output of A202 exceeds the output of A201. This typically occurs when the charging current drops to a predetermined fraction of its initial value (i.e., the value at the start of the second charging phase). After a predetermined period dictated by the latch circuitry L, the SHUTDOWN signal is set to a logic high, turning off Q204 and opening switch SB. This ends the charging cycle.

The predetermined fractional relationship between the initial and final charging current is determined by a fractional relationship between the initial and final current flowing through R204 (i.e., I₁). Since the sum of I₁ and I₂ remains equal to the bandgap reference current, varying I₂ allows adjustment to I₁. For example, increasing I₂ reduces I₁. Assuming, for example, that I₁ and I₂ are equal, the final I₁ value is one-half the initial I₁ value. If, for example, I₂ were ten times I₁, the final I₁ value would be one-tenth the initial I₁ value. When I₁ reaches its final value, the CONTROL and SHUTDOWN signals transition to a high state, reducing and turning off battery charging current.

I₂ represents the current that Q201 sinks into R203. I₂ is determined by the active area of Q201. The larger the active area, the greater the amount of current at the same gate voltage. In one embodiment of the invention, Q201 is fabricated with an area ten times that of Q202. This results in approximately ten times more current flowing through Q201 compared to Q202. In another embodiment, one or more switched FETs are placed in parallel with Q201. As shown in FIG. 23, FETs Q201A, Q201B, Q201C are connected to V_{BUS} through switches (e.g., transmission gates) S201, S202, S203. (Although only three additional FETs and switches are shown in FIG. 23, this is for clarity only. Any number of additional FETs and switches may be used and would still be within the scope of this invention.) The camera firmware sets the position (i.e., open or closed) of the switches S201, S202, S203. This allows for adjustment of the charging parameters such as, for example, the final charging current in the second charging phase, after camera manufacture. A benefit of is that changes to the charging system can be made in the field via a firmware upgrade, typically delivered via the USB.

The Power Management Subsystem includes an arbitrator to control the various power states of the camera to minimize power dissipation and extend battery life. As depicted in the table below, there are four power states:

| State | Microprocessor | Clock | Power |
|---|---|---|---|
| Name | State | State | State |
| ON | ON | ON | ON |
| REST | REST | ON | ON |
| SLEEP | REST | OFF | ON |
| OFF | OFF | OFF | OFF |

The ON state is the normal operating mode for the camera. In this state, all camera circuitry, including the microprocessor, is powered and ready for taking photographs. The imaging electronics are also fully powered and are performing constant exposure control adjustments. (This is sometimes termed “video mode.”) Because this state requires the most power, time spent in this state must be minimized to preserve battery life. Accordingly, the camera firmware includes a provision for placing the camera into a REST state during periods of inactivity. In one embodiment, the camera toggles between the ON and REST states at one second intervals when there is no user activity.

Typically, placing the camera into the REST state includes providing the microprocessor with a corresponding REST instruction. The REST instruction essentially halts the microprocessor in a known state. The clock remains on and the camera circuitry remains powered, albeit with the imaging electronics receiving less current. The power savings associated with the halted microprocessor and reduced current to the imaging electronics help extend the battery life.

Even when in the REST state, the imaging electronics are readjusting the exposure. Because the power is limited to the imaging electronics, the exposure data have more noise compared to data acquired at full power. (For example, the settling time of the analog to digital converters is compromised, so the acquired data are “coarse” compared to that obtained at full power.) When the camera returns to the ON state, data from the fully powered imaging electronics are used to adjust the preliminary exposure control data obtained in the REST state. This saves additional power.

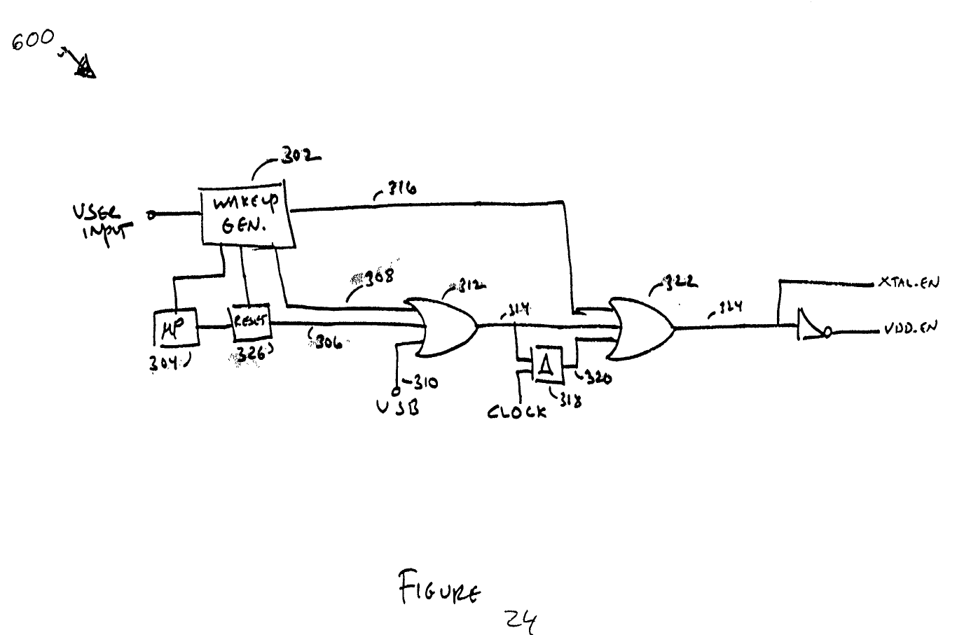

The SLEEP state generally results after an extended period of no activity. In one embodiment, this period is thirty seconds. When in the SLEEP state, the microprocessor is halted and the clock is turned off. As discussed below in conjunction with FIG. 24, user input detected when in the SLEEP state is examined for validity. If the input is valid, the microprocessor is restarted for further processing.

In one embodiment, the camera toggles between the ON and SLEEP modes instead of between the ON and REST modes. This embodiment allows for further power savings because the SLEEP mode requires less power than the REST mode. Nevertheless, in one embodiment additional time (approximately thirty milliseconds to one second) is required before the camera is ready to take photographs, because the camera electronics need extra time to stabilize after being in the SLEEP state.

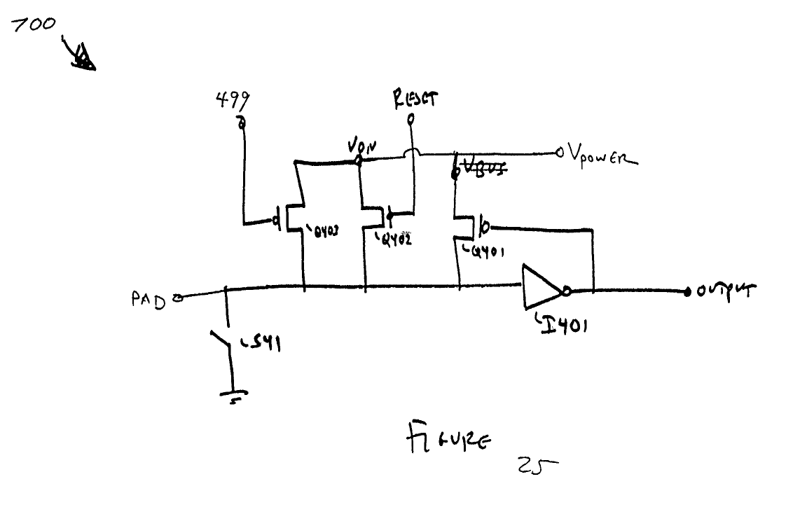

The OFF state typically follows the SLEEP state when there is no further user activity. (The OFF state also results when the user turns the camera off.) In one embodiment, the OFF state begins five seconds after entering the SLEEP state. In the OFF state, the microprocessor is halted, the clock is turned off, and the camera electronics, with the exception of certain power management circuitry as discussed below and in conjunction with FIGS. 24 and 25, are powered-off. In this configuration, the camera is dissipating the minimum amount of power.

FIG. 24 depicts an embodiment of wakeup circuitry 600. A wakeup generation module 302 is in electrical communication with the camera user interface. This user interface includes several buttons and switches for operating the camera. Examples include a shutter button and a lens activation button. When the wakeup generation module 302 detects user interface activity (i.e., a “request”), it activates the clock and power to examine the nature of the activity, but keeps the microprocessor 304 in the REST state. If the request is valid, the microprocessor 304 is restarted. Otherwise, the camera returns to the OFF state, typically within 300 milliseconds after the detecting the request. Valid requests are typically those that are (1) not masked by the microprocessor per the firmware, (2) persist for at least, for example, thirty milliseconds for deglitching, and (3) satisfy a 300 millisecond (typical) debounce time.

Once the microprocessor 304 is restarted, it provides a keep alive signal 306 to OR gate 312 via a failsafe reset module 326. The OR gate 312 also receives a wakeup signal 308 and from the wakeup generation module 302, and a USB signal 310. These three signals determine whether the camera will remain out of the SLEEP and OFF states. Specifically, USB signal 310 is active when the camera is connected to a PC host, thereby receiving external power, so managing power consumption is less important than when the camera is obtaining power from the Li battery. Wakeup signal 308 is active when the wakeup generation module 302 detects a request. Finally, the microprocessor 304 asserts the keep alive signal 306 to command clock and power. As long as one of these three signals (keep alive signal 306, wakeup signal 308, and USB signal 310) are active, the output 314 of the OR gate 312 will be set to a logic high.

OR gate 322 receives a clock enable signal 316 from the wakeup generation module 302, the output 314 of the OR gate 312 and, by virtue of a pipeline register 318, a time shifted version 320 of the output 314 of the OR gate 322. The inclusion of the pipeline register 318, which is driven by the clock, minimizes or eliminates signal glitches and ensures a graceful shutdown. In one embodiment, the pipeline register 318 delays signal 314 by four clock cycles. The output 324 of the OR gate 322 is used to activate the clock and, after inversion, is used to enable the camera power.

When the user wants to turn off the camera, the wakeup generation module 302 pulls both the wakeup signal 308 and the clock enable signal 316 low. Assuming the camera is disconnected from the USB, USB signal 310 will also be low. Under normal operation, the microprocessor 304 will then pull the keep alive signal 306 low, thereby pulling output 314 of the OR gate 312 low. After a delay associated with pipeline register 318, the output 324 of the OR gate 322 is set to a logic low, thereby turning off the clock and power. To ensure that the microprocessor 304 does not inadvertently continue to assert the keep alive signal 306 (thereby preventing the camera from turning off), the wakeup generation module 302 triggers the failsafe reset module 326. The failsafe reset module 326 then begins a countdown that, in one embodiment, is approximately twenty seconds. If, at the end of the countdown, the microprocessor 304 is continuing to assert the keep alive signal 306, the failsafe reset module 326 forces the keep alive signal 306 low. This causes the output 314 to be set to a logic low and completes the power off sequence described above. Powering off the microprocessor 304 in this fashion will cause it to reset on power up. On the other hand, if the microprocessor 304 properly pulls the keep alive signal 306 low, the camera will turn off without the intervention of the failsafe reset module 326.

FIG. 25 depicts an actuating portion 700 of the user interface in accordance with an embodiment of the invention. Switch or button S41 is typically mounted on the exterior of the camera, accessible to the user. The source of FETs Q401, Q402, Q403 are connected to V_{POWER} and derives its power from either the USB or Li battery, depending on whether the camera is connected or disconnected, respectively, from the USB. FETs Q401, Q402, Q403 share a common source connection to a power source V_{POWER} that is always on. RESET is strobed, in one embodiment, with a one hertz signal derived from the clock, whenever the clock is on.

When S41 is closed, the output of inverter I401 is set to a logic high, thereby turning off Q401. Conversely, if S41 is open, and if PAD is pulled up through Q402 or Q403, the output of inverter I401 is set to a logic low. This turns on Q401, which latches the output of inverter I401 in the low state. Q402 provides an active pull up for S41. Because the gate of Q402 is strobed by RESET, there is no continuous power drain associated with the pull up, even when the user holds S41 in the closed position, and the corresponding power saving is proportional to the RESET duty cycle.

As discussed above, after predetermined periods the camera will go into the SLEEP or OFF states wherein the clock is turned off. Consequently, the active pull up provided by Q402 can no longer be strobed because the clock is stopped. In this instance, the pull-up signal 499 is set to a logic low and Q403 provides a conventional, albeit weak (i.e., highly resistive), pull up. This pull up requires only a small amount of current, but provides sufficient bias to pull up PAD. Consequently, the camera will detect a change in the state of S41 even when the clock is not running, e.g., when the camera is in the SLEEP or OFF state.

The camera can include one or more buttons or switches, each with circuitry exemplified by FIG. 25. In one embodiment, as many as seven different switches, or buttons, or both, are included.

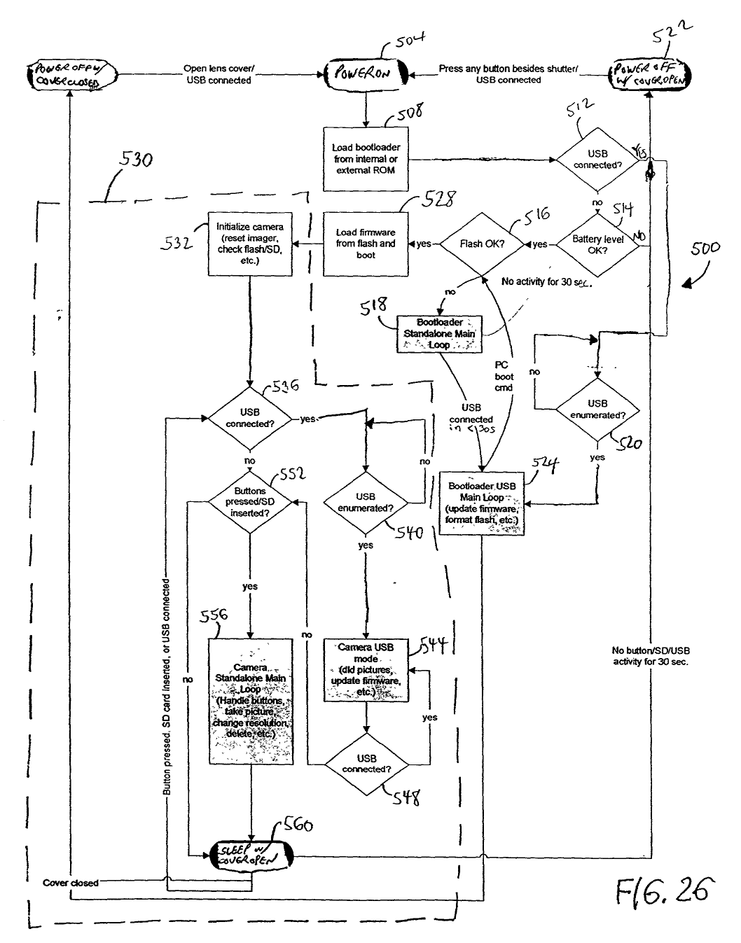

The camera firmware can be upgraded via a host computer. For example, alternate firmware versions or improvements can be downloaded from a remote site to the host computer and then downloaded directly to the camera. FIG. 26 is a flowchart of one embodiment of a series of steps describing camera operation, including the downloading of firmware under various operational conditions.

In step 504 the camera receives normal operating power in response to the opening of the lens cover, the pressing of a camera button or connection to a USB port of a host computer. Hardware code is loaded from internal or external camera ROM (step 508) before the battery voltage level is compared to a reference voltage (e.g., 4.2 volts) in step 512. If the battery voltage exceeds the reference voltage, the embedded flash memory is examined to see if it has been corrupted (step 516). If the flash memory is valid, the firmware is loaded from the flash memory and the camera is rebooted (step 520). Conversely, if the flash memory is determined to be invalid, the camera is receives a firmware download from the host PC.

The camera firmware can be upgraded via a host computer. For example, alternate firmware versions or improvements can be downloaded from a remote site to the host computer and then downloaded directly to the camera. FIG. 26 is a flowchart of one embodiment of a method 500 of digital camera operation, including the downloading of firmware under various operational conditions. The camera receives normal operating power (step 504) in response to the opening of the lens cover, the pressing of a camera button or the connection of the camera to a host computer. Hardware code (i.e., a bootloader code) is loaded from internal ROM or external camera ROM (step 508). After completion, a determination (step 512) is made as to whether the camera is coupled to a host computer. If a USB connection is not detected, the battery voltage is examined (step 514) to see if it exceeds a threshold voltage level (e.g., 4.2 volts). If the battery voltage exceeds the threshold voltage, the flash memory is examined (step 516) to determine whether it is valid or corrupted. If the battery voltage does not exceed the threshold voltage, the camera electrical power is reduced (step 522) until a wakeup event occurs so that normal camera power (504) is provided to the camera electronics. If a USB connection is detected in step 512, the camera waits for enumeration (step 510) of the USB communication.

In the illustrated method 500, the bootloader USB main loop (step 524) is executed if one of two conditions exists: (1) USB enumeration (step 514) is successful, or (2) the flash memory is determined to be corrupted or otherwise invalid. Under the latter condition, the method 500 proceeds to execute a standalone bootloader loop (step 518) to enable updating of the firmware in later executed steps. If a USB connection is not established within a predetermined time (e.g., 30 seconds) the camera is placed in a low power or sleep mode (step 522), otherwise the method 500 enters the bootloader USB main loop (step 524).

In one embodiment of the bootloader USB main loop, if any difference is detected between the camera ROM file and the ROM file maintained on the PC, the latter file is written into the camera ROM to replace the existing camera ROM file. This remedies a situation in which the camera enters an inoperable state caused by invalid or otherwise corrupted firmware. Under this situation, the camera can be revived by downloading an updated version of the firmware provided to the user's PC for example, from the Internet or a portable storage medium. Execution of the bootloader USB main loop can also include updating the firmware and/or formatting the flash device under the control of the host PC in other ways. For example, customized firmware can be generated by the user on the host PC and then downloaded to the camera. In one embodiment, customized firmware includes user modification of parameters within a generic ROM file. As updated firmware is provided to the user, previously selected parameter values are preserved. Consequently, the user does not have to re-enter parameters each time an update is received.

The method 500 proceeds to step 516 after completion of the bootloader main loop functions to confirm the validity of the flash memory. Subsequently, the method proceeds to load the firmware from the flash device and completes initialization (i.e., boots) (step 528). The camera is then operated according to a series of steps 530 as defined by the camera firmware. In the illustrated embodiment the method 500 continues by initializing camera functions (step 532). If a determination is made that the camera is connected and enumerated via USB (steps 536 and 540, respectively), the camera establishes itself in USB mode (step 544). USB mode permits, for example, pictures to be transferred to the host PC and camera firmware to be changed. If it is determined (step 536 or step 548) that the camera is not connected via USB, a determination (step 552) is made as to whether camera actuators or buttons have been pressed, or an external memory card (SD) has been inserted. If such an event is detected, the camera operates in a standalone mode (step 556), otherwise, after expiration of a predetermined time (e.g., 30 seconds) the camera enters sleep mode (step 560) to conserve battery power. Standalone mode includes, for example, processing camera functions initiated by pressing actuators, acquiring pictures, changing camera resolution, processing acquired pictures (e.g., deleting unwanted pictures) and other camera functions performed under normal power conditions.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A digital camera comprising:
a control subsystem comprising a microprocessor;
an imaging subsystem in communication with the control subsystem; and
a power management subsystem in communication with the control subsystem, the power management subsystem comprising:
power selection-isolation circuitry for isolating at least two power sources;
battery charging circuitry in communication with the power selection-isolation circuitry; and
power arbitration circuitry in communication with the power selection-isolation circuitry and the battery charging circuitry.

2. The digital camera of claim 1 further comprising a user interface subsystem for providing a camera status and initiating a camera function.

3. The digital camera of claim 2 wherein the power arbitration circuitry comprises:
a camera wakeup generation module in communication with the user interface subsystem; and
a failsafe reset module in communication with the wakeup generation module and the microprocessor.

4. The digital camera of claim 3 wherein the user interface subsystem comprises:
a user accessible actuator for implementing a camera function;
an inverter having an input in communication with the user accessible actuator and an output in communication with the wakeup generation module;
an active pull-up latch in communication with the inverter input and the inverter output;
a first active pull-up in communication with the inverter input adapted to receive a first control signal; and
a second active pull-up in communication with the inverter input adapted to receive a second control signal.

5. The digital camera of claim 4 wherein the user accessible actuator comprises a switch.

6. The digital camera of claim 4 wherein the user accessible actuator comprises a button.

7. The digital camera of claim 4 wherein the first control signal comprises a strobed signal.

8. The digital camera of claim 4 wherein the second control signal comprises a logic signal active at a power off state.

9. The digital camera of claim 1 wherein the battery charging circuitry comprises:
a first transistor having a first active area;
a second transistor having a second active area, the second transistor connected to the first transistor in a differential configuration; and
at least one supplemental transistor having a supplemental active area, the supplemental transistor connected in series with a supplemental switch, the supplemental transistor and supplemental switch further connected in parallel with the second transistor.

10. The digital camera of claim 9 wherein the second active area is about ten times the first active area.

11. The digital camera of claim 9 wherein the supplemental switch has a state established by a firmware instruction.

12. The digital camera of claim 1 wherein the power selection-isolation circuitry comprises a power arbitration circuit comprising:
a battery power bus;
an external power bus;
a first transistor adapted to receive a battery enabling signal, the first transistor having a first shunt diode, the first shunt diode having a first shunt anode and a first shunt cathode, the first shunt anode in communication with the battery power bus; and
a second transistor adapted to receive a bus enable signal, the second transistor having a second shunt diode, the second shunt diode having a second shunt anode and a second shunt cathode, the second shunt anode in communication with the external power bus and the second shunt cathode in communication with the first shunt cathode.

13. The digital camera of claim 12 wherein the first shunt diode comprises a parasitic component of the first transistor.

14. The digital camera of claim 12 wherein the second shunt diode comprises a parasitic component of the second transistor.

15. The digital camera of claim 1 wherein the power selection-isolation circuitry comprises:
a battery power bus;
an external power bus;
a first transistor adapted for receiving a shutdown signal having a first shunt diode, the first shunt diode having a first shunt anode and a first shunt cathode, the first shunt cathode in communication with the external power bus;
a second transistor adapted for receiving the shutdown signal having a second shunt diode, the second shunt diode having a second shunt anode and a second shunt cathode, the second shunt anode in communication with the first shunt anode; and
a third transistor adapted for receiving a control signal having a third shunt diode, the third shunt diode having a third shunt anode in communication with the battery power bus, and a third shunt cathode in communication with the second shunt cathode.

16. The digital camera of claim 15 wherein the first shunt diode comprises a parasitic component of the first transistor.

17. The digital camera of claim 15 wherein the second shunt diode comprises a parasitic component of the second transistor.

18. The digital camera of claim 15 wherein the third shunt diode comprises a parasitic component of the third transistor.

19. A camera body having a tongue and groove configuration comprising:
a front cover having a first front edge and a second front edge, each of the first front edge and the second front edge having a lip;
a rear cover having a first rear edge and a second rear edge, each of the first rear edge and the second rear edge having a lip;
a first rail having a groove adapted to receive the lip of the first front edge and the lip of the first rear edge; and
a second rail having a groove adapted to receive the lip of the second front edge and the lip of the second rear edge,
wherein the front cover and the rear cover are held in substantial parallel alignment when the front edge lip and the rear edge lip are received in the groove of the first rail and the second rail, respectively.

20. The camera body of claim 19 further comprising a third front edge, a third rear edge, and an end cap adapted to receive the third front edge and the third rear edge.

21. The camera body of claim 19 wherein the first rail and the second rail each has a first end and a second end, each of the first and second ends having a threaded hole configured to receive a fastening screw.

22. The camera body of claim 21 further comprising an end cap and a pair of fastening screws, the end cap being fastened to the first and second rails at each of the threaded holes by a respective one of the fastening screws.

23. A rechargeable camera power source comprising:
a printed circuit board having a first side, a second side and a pair of conductive pads disposed on the second side, the board defining a pair of apertures, each of the apertures configured to provide a passage between the first side and the second side; and
a rechargeable battery comprising:
a planar battery body disposed substantially parallel and adjacent to the first side of the printed circuit board; and
a pair of conformable battery terminals, each of the terminals passing through a respective board aperture and bonded to a respective one of the conductive pads.

24. The power source of claim 23 wherein the rechargeable camera power source is permanently fixed to the printed circuit board.

25. A retractable and extendable lens holder comprising:
a lens mount adapted to hold a lens assembly;
a camera body surface; and
a biasing component disposed between the lens mount and the camera body surface, the biasing component configured to move the lens assembly from a stored position to an operating position.

26. The lens holder of claim 25 wherein the distance from the lens assembly in the operating position to an imager chip is substantially a focal distance of the lens assembly.

27. The lens holder of claim 25 wherein the biasing component is a spring.

28. A retractable and extendable lens holder comprising:
a lens mount adapted to hold a lens assembly;
a camera body surface; and
a pivoting linkage coupled to the camera body surface and the lens mount, the pivoting linkage adapted to move the lens mount between a first position adjacent to an imager chip and a second position in front of the imager chip,
wherein an axis of the lens assembly is substantially normal to and centered on an imaging surface of the imager chip when the lens mount is in the second position.

29. A retractable and extendable lens holder comprising:
a lens holder;
a camera body surface;
a ramp arm having a pivot axis parallel to the camera body surface;
a retraction device coupled to the ramp arm; and
an angular bias component having a first bias arm, a second bias arm and a bias axis, the bias axis being parallel to pivot axis;
wherein the retraction device is disposed relative to the ramp arm such that the retraction device moves the ramp arm to a first position when the lens holder is in an operating position and the retraction device moves the ramp arm to a second position when the lens holder is in a stored position.

30. The lens holder of claim 29 wherein the retraction device is a cover plate adapted for sliding parallel to the camera body surface.

31. The lens holder of claim 29 wherein the angular bias component is a turn spring.

32. A retractable and extendable lens holder comprising:
a dome switch having a bistatic surface and having a base adapted for mounting to a camera body surface, the bistatic surface having a first stable position and a second stable position defining a first surface and a second surface, respectively;
a lens holder coupled to the bistatic surface of the dome switch;
wherein the lens holder is disposed at a first lens position in response to the bistatic surface changing from the second surface to the first surface and wherein the lens holder is disposed at a second lens position in response to the bistatic surface changing from the first surface to the second surface.

33. The lens holder of claim 32 wherein the bistatic surface of the dome switch changes from one of the first surface and the second surface to the other of the first surface and the second surface in response to a temporary pressure applied to the bistatic surface.

34. The lens holder of claim 32 further comprising a dome assist mechanism coupled to the camera surface and the bistatic surface of the dome switch, the dome assist mechanism moving the bistatic surface of the dome switch from the second surface to the first surface in response to a temporary pressure applied to the bistatic surface.

35. A digital camera comprising:
a camera body having a thickness;
a lens holder mounted to the camera body;
a viewfinder objective lens disposed in the lens holder;
a viewfinder eyepiece mounted to the camera body,
wherein the a working length of the viewfinder objective lens and the viewfinder eyepiece is greater than the thickness of the camera body.

36. A digital camera comprising:
a camera body having a thickness;
a lens holder mounted to the camera body;
a viewfinder eyepiece disposed in the lens holder;
a viewfinder objective lens mounted to the camera body,
wherein the a working length of the viewfinder objective lens and the viewfinder eyepiece is greater than the thickness of the camera body.

37. The camera of claim 35 wherein the viewfinder eyepiece is moveable to change a separation between the viewfinder eyepiece and the viewfinder objective lens.

38. A digital camera comprising:
a means for controlling operation;
a means for acquiring an image;
a means for managing power in communication with the acquiring means, the power-management means comprising;
a means for controlling power
a means for charging a battery in communication with the power-control means;
a means for arbitrating power in communication with the power-control means and the battery-charging means.
